(19) United States
(12) Patent Application Publication
(10) Pub. No.: US 2026/0089245 A1
(43) Pub. Date: Mar. 26, 2026

(54) METHOD FOR WIRELESS COMMUNICATION AND TRANSMITTING DEVICE

(71) Applicant: GUANGDONG OPPO MOBILE TELECOMMUNICATIONS CORP., LTD., Dongguan (CN)

(72) Inventors: Ning GAO, Dongguan (CN); Yapu LI, Dongguan (CN); Chaoming LUO, Dongguan (CN); Pei ZHOU, Dongguan (CN)

(21) Appl. No.: 19/406,913

(22) Filed: Dec. 2, 2025

Related U.S. Application Data
(63) Continuation of application No. PCT/CN2023/099195, filed on Jun. 8, 2023.

(51) Int. Cl. H04L 69/323; H04L 5/00

(52) U.S. Cl. CPC H04L 69/323; H04L 5/0098

(57) ABSTRACT

A method for wireless communication and a transmitting device are provided. The method includes the following. A transmitting device transmits an ultra-high reliability (UHR) physical layer (PHY) protocol data unit (PPDU), where the UHR PPDU contains at least one of: a legacy short training field (L-STF), a legacy long training field (L-LTF), a legacy signal field (L-SIG), a repeated legacy signal field (RL-SIG), a universal signal field (U-SIG), an ultra-high reliability signal field (UHR-SIG), an ultra-high reliability short training field (UHR-STF), an ultra-high reliability long training field (UHR-LTF), a data field, or a packet extension (PE) field.

### CROSS REFERENCE TO RELATED APPLICATION(S)

This application is a continuation of International Application No. PCT/CN2023/099195, filed Jun. 8, 2023, the entire disclosure of which is incorporated herein by reference.

### TECHNICAL FIELD

This disclosure relates to the field of communication, in particular to a method for wireless communication and a transmitting device.

### BACKGROUND

In a multiple-user (U) detection scenario, detection of multiple users can be implemented through a null data physical layer protocol data unit (NDP) feedback report poll (NFRP) and a high-efficiency (HE) trigger-based (TB) feedback NDP (HE TB feedback NDP). Specifically, an access point (AP) device transmits an NFRP frame to one or more station (STA) devices, to trigger each of the STA devices to transmit an HE TB feedback NDP, and the AP device knows, by parsing the HE TB feedback NDP, an STA device(s) that need to participate in subsequent MU uplink (UL) transmission. Based on this, the AP device reasonably allocates resources to the STA device(s) in a subsequent trigger frame, thereby completing the MU UL transmission.

However, there is still room for further improvement in the method for MU detection.

### SUMMARY

In a first aspect, a method for wireless communication is provided. The method includes the following. A transmitting device transmits an ultra-high reliability (UHR) physical layer (PHY) protocol data unit (PPDU), where the UHR PPDU contains at least one of: a legacy short training field (L-STF), a legacy long training field (L-LTF), a legacy signal field (L-SIG), a repeated legacy signal field (RL-SIG), a universal signal field (U-SIG), an ultra-high reliability signal field (UHR-SIG), an ultra-high reliability short training field (UHR-STF), an ultra-high reliability long training field (UHR-LTF), a data field, or a packet extension (PE) field.

In a second aspect, a transmitting device is provided. The transmitting device includes a processor and a memory. The memory is configured to store a computer program. The processor is configured to invoke and execute the computer program stored in the memory, to cause the transmitting device to perform the method in the first aspect.

### BRIEF DESCRIPTION OF THE DRAWINGS

FIG. 1 is a schematic architectural diagram of a communication system provided in embodiments of the present disclosure.

FIG. 2 is a schematic diagram of a format of an EHT MU PPDU.

FIG. 3 is a schematic diagram of a format of an EHT TB PPDU.

FIG. 4 is a schematic diagram illustrating an MU UL detection process.

FIG. 5 is a schematic diagram of a frame format of an NFRP trigger frame.

FIG. 6 is a schematic diagram of a format of a common info field in an NFRP trigger frame.

FIG. 7 is a schematic diagram of a format of a user info list field in an NFRP trigger frame.

FIG. 8 illustrates a format of an HE TB feedback NDP.

FIG. 9 is a schematic diagram illustrating an interaction of a method for wireless communication 200 according to embodiments of the present disclosure.

FIG. 10 is a schematic diagram of a format of a UHR MU PPDU or a UHR ER PPDU carrying an identifier (ID) field according to embodiments of the present disclosure.

FIG. 11 is a schematic diagram of a format of a UHR TB PPDU carrying an ID field according to embodiments of the present disclosure.

FIG. 12 is a schematic diagram of a format of a UHR MU PPDU or UHR ER PPDU carrying an ID field and a reverse interval field according to embodiments of the present disclosure.

FIG. 13 is a schematic diagram of a format of a UHR TB PPDU carrying an ID field and a reverse interval field according to embodiments of the present disclosure.

FIG. 14 is a schematic diagram of a format of another UHR MU PPDU or UHR ER PPDU carrying an ID field according to embodiments of the present disclosure.

FIG. 15 is a schematic diagram of a format of another UHR TB PPDU carrying an ID field according to embodiments of the present disclosure.

FIG. 16 is a schematic diagram of a format of another UHR MU PPDU or UHR ER PPDU carrying an ID field and a reverse interval field according to embodiments of the present disclosure.

FIG. 17 is a schematic diagram of a format of another UHR TB PPDU carrying an ID field and a reverse interval field according to embodiments of the present disclosure.

FIG. 18 is a schematic diagram of a format of an ID field according to embodiments of the present disclosure.

FIG. 19 is a schematic diagram of a format of another ID field according to embodiments of the present disclosure.

FIG. 20 is a schematic diagram of a format of yet another ID field according to embodiments of the present disclosure.

FIG. 21 is a schematic diagram of a format of yet another ID field according to embodiments of the present disclosure.

FIG. 22 is a schematic diagram of a format of yet another ID field according to embodiments of the present disclosure.

FIG. 23 is a schematic diagram of a format of a UHR MU PPDU with control information of an ID field carried in a U-SIG field according to embodiments of the present disclosure.

FIG. 24 is a schematic diagram of a format of a UHR TB PPDU with control information of an ID field carried in a U-SIG field according to embodiments of the present disclosure.

FIG. 25 is a schematic diagram of a format of a UHR ER PPDU with control information of an ID field carried in a U-SIG field according to embodiments of the present disclosure.

FIG. 26 is a schematic diagram of a format of a UHR MU PPDU with control information of an ID field carried in a common field in a UHR-SIG field according to embodiments of the present disclosure.

FIG. 27 to FIG. 34 are flowcharts each illustrating PPDU reception by a physical layer (PHY) of a receiving device according to embodiments of the present disclosure.

FIG. 35 to FIG. 40 are schematic diagrams each illustrating an application scenario of a method for MU detection according to embodiments of the present disclosure.

FIG. 41 is a schematic block diagram of a transmitting device according to embodiments of the present disclosure.

FIG. 42 is a schematic block diagram of a receiving device according to embodiments of the present disclosure.

FIG. 43 is a schematic block diagram of a communication device according to embodiments of the present disclosure.

FIG. 44 is a schematic block diagram of a chip according to embodiments of the present disclosure.

FIG. 45 is a schematic block diagram of a communication system according to embodiments of the present disclosure.

### DETAILED DESCRIPTION

The technical solutions of embodiments of the present disclosure are described below with reference to the accompanying drawings. It is apparent that the described embodiments are only part of, rather than all of, embodiments of the present disclosure. All other embodiments obtained by those of ordinary skill in the art without creative effort based on the embodiments in the present disclosure shall fall within the protection scope of the present disclosure.

The technical solutions of embodiments of the present disclosure are applicable to various communication systems, such as wireless local area networks (WLAN), wireless fidelity (WiFi), or other communication systems.

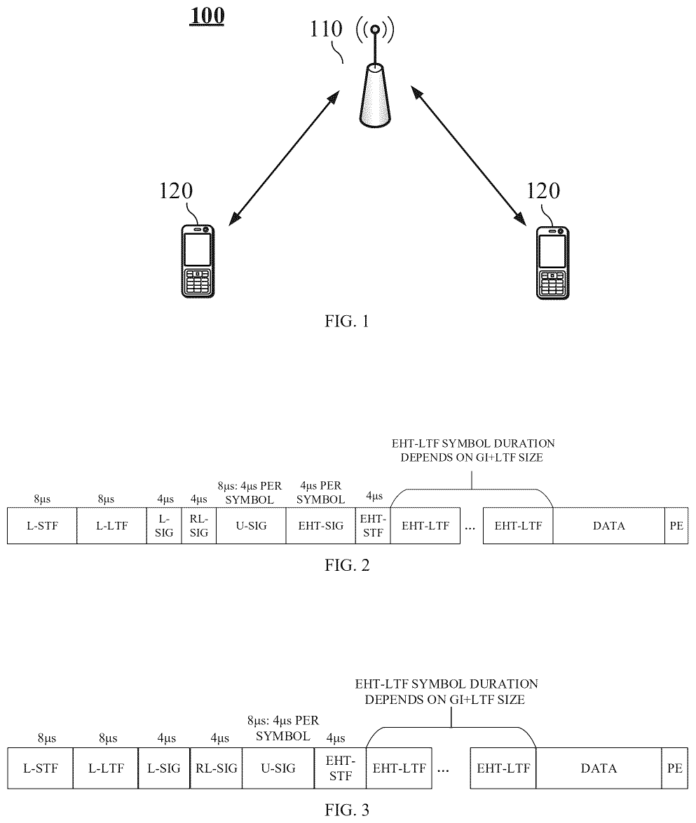

Exemplarily, FIG. 1 illustrates a communication system 100 to which embodiments of the present disclosure are applicable. The communication system 100 may include an access point (AP) 110 and a station (STA) 120 that accesses the network through the AP 110.

In some scenarios, the AP is also referred to as an AP STA, that is, in a certain sense, the AP is also the type of STA.

In some scenarios, the STA is also referred to as a non-AP STA.

The communication in the communication system 100 may occur between an AP and a non-AP STA, between non-AP STAs, or between an STA and a peer STA. The peer STA may refer to a device for communicating with a peer of the STA. For example, the peer STA may be an AP or a non-AP STA.

The AP may be a bridge for connecting a wired network and a wireless network. The AP is mainly used for connecting various wireless network clients together and then connecting the wireless network to an Ethernet. The AP may be a terminal device (for example, a mobile phone) having a Wi-Fi chip or a network device (for example, a router).

It may be understood that, a role of the STA in the communication system is not absolute. For example, in some scenarios, when a mobile phone is connected to a router, the mobile phone is a non-AP STA. When the mobile phone is a hotspot for another mobile phone, the mobile phone serves as an AP.

The AP and the non-AP STA may be devices applied to vehicle to everything (V2X); internet of things (IoT) nodes, sensors, etc. in IoT; smart cameras, smart remote controls, smart water meters and electricity meters, etc. in smart home; sensors in smart city, etc.

In some embodiments, the non-AP STA may support 802.11be standards. The non-AP STA may also support various current and future 802.11 WLAN standards, such as 802.11ax, 802.11ac, 802.11n, 802.11g, 802.11b, 802.11a, etc.

In some embodiments, the AP may be a device that supports 802.11be standards. The AP may also be a device that supports various current and future 802.11 WLAN standards, such as 802.11ax, 802.11ac, 802.11n, 802.11g, 802.11b, 802.11a, etc.

In embodiments of the present disclosure, the STA may be a device supporting WLAN or Wi-Fi technology, such as a mobile phone, a tablet (pad), a computer, a virtual reality (VR) device, an augmented reality (AR) device, a wireless device in industrial control, a set-top box, a wireless device in self-driving, an in-vehicle communication device, a wireless device in remote medicine, a wireless device in smart grid, a wireless device in transportation safety, a wireless device in smart city or a wireless device in smart home, a wireless communication chip/an application specific integrated circuit (ASIC)/a system-on-chip (SOC), etc.

A frequency band supported by WLAN technology may include, but is not limited to, a low frequency band (2.4 Giga Hertz (GHz), 5 GHz, and 6 GHz), and a high frequency band (45 GHz, 60 GHz).

FIG. 1 exemplarily illustrates one AP STA and two non-AP STAs. Optionally, the communication system 100 may include multiple AP STAs and other numbers of non-AP STAs, which is not limited in embodiments of the present disclosure.

It may be understood that, in embodiments of the present disclosure, a device with communication functions in a network/system can be referred to as “communication device”. Taking the communication system 100 illustrated in FIG. 1 as an example, the communication device may include the AP 110 and the STA(s) 120 that have communication functions. The AP 110 and the STA(s) 120 can be the devices described above and will not be repeated herein. The communication device may further include other devices such as a network controller, a mobility management entity (MME), or other network entities in the communication system 100, which is not limited in embodiments of the present disclosure.

It may be understood that, the terms “system” and “network” herein are usually used interchangeably throughout this disclosure. The term “and/or” herein only describes an association between associated objects, which means that there can be three relationships. For example, A and/or B can mean A alone, both A and B exist, and B alone. In addition, the character “/” herein generally indicates that the associated objects are in an “or” relationship.

It may be understood that, “indication” referred to in embodiments of the present disclosure may be a direct indication, may be an indirect indication, or may mean that there is an association. For example, A indicates B may mean that A directly indicates B, for instance, B can be obtained according to A; may mean that A indirectly indicates B, for instance, A indicates C, and B can be obtained according to C; or may mean that there is an association between A and B.

In the elaboration of embodiments of the present disclosure, the term “correspondence” may mean that there is a direct or indirect correspondence between the two, or may mean that there is an association between the two, or may mean a relationship of indicating and being indicated or configuring and being configured, etc.

In embodiments of the present disclosure, the “pre-defined” or “pre-configured” can be implemented by pre-storing a corresponding code(s) or a corresponding table(s) in a device (for example, including the AP and the STA) or in other manners that can be used for indicating related information, and the present disclosure is not limited in this regard. For example, the “pre-defined” may mean defined in a protocol.

In order to facilitate the understanding of the technical solutions of embodiments of the present disclosure, related terms in the present disclosure are described below.

Association identifier (AID) is used for identifying a terminal that has established an association with an AP.

Unassociation identifier (UID) is used for identifying a terminal that is not established an association with an AP.

Medium access control (MAC) is an abbreviation of medium access control address.

Transmission opportunity (TXOP) refers to a period of time during which a terminal with an TXOP can actively initiate one or more transmissions.

An extremely high throughput (EHT) physical layer (PHY) protocol data unit (PPDU) related to the present disclosure is described below.

The IEEE 802.11be standard defines two types of EHT PPDUs in EHT PHY: EHT multiple-user (MU) PPDU and EHT trigger-based (TB) PPDU.

FIG. 2 is a schematic diagram of a format of an EHT MU PPDU. As illustrated in FIG. 2, the EHT MU PPDU can contain the following fields: a legacy short training field (L-STF), a legacy long training field (L-LTF), a legacy signal field (L-SIG), a repeated legacy signal field (RL-SIG), a universal signal field (U-SIG), an EHT signal field (EHT-SIG), an EHT short training field (EHT-STF), an EHT long training field (EHT-LTF), a data field, and a packet extension (PE) field. The L-STF has a fixed waveform and is used for PPDU discovery and initial time-frequency synchronization. The L-LTF has a fixed waveform and is used for initial channel estimation and further time-frequency synchronization. The L-SIG has a variable waveform and is used for carrying information required for parsing a PPDU. The RL-SIG is a repetition of an L-SIG. The U-SIG has a variable waveform and is used for carrying information required for parsing an EHT PPDU. The EHT-SIG has a variable waveform and is used for carrying information related to downlink (DL) MU transmission. The EHT-STF has a fixed waveform and is used for receiver automatic gain control (AGC). The EHT-LTF has a variable waveform and is used for channel estimation. The data field has a variable waveform and is used for carrying data. The PE field has a variable waveform and is used for extending a duration of a PPDU, providing a receiver with more time for processing and response.

FIG. 3 is a schematic diagram of a format of an EHT TB PPDU. Unlike the EHT MU PPDU, the EHT TB PPDU does not contain an EHT-SIG field, and the meanings of other fields are similar to the meanings of corresponding fields in the EHT MU PPDU.

A null data physical layer protocol data unit (NDP) feedback report mechanism is explained below.

The IEEE 802.11ax defines an MU uplink (UL) detection mechanism which enables an AP to detect a non-AP STA(s) that requires resource allocation before transmitting a trigger frame.

The MU UL detection mechanism in the IEEE 802.11ax also defines two related frame structures: an NDP feedback report poll (NFRP) trigger frame and a high efficiency (HE) TB feedback NDP.

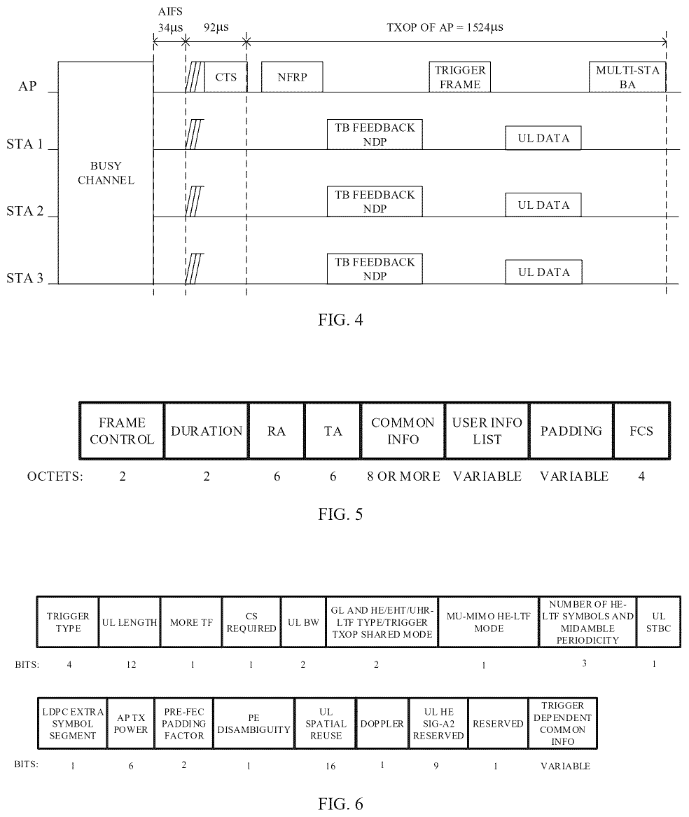

FIG. 4 is a schematic diagram illustrating an MU UL detection process. As illustrated in FIG. 4, an AP transmits an NFRP frame to one or more non-AP STAs, to trigger each of the non-AP STAs to transmit an HE TB feedback NDP, and the AP device can know, by parsing the HE TB feedback NDP, which non-AP STAs need to participate in subsequent MU UL transmission. Based on this, the AP device reasonably allocates resources to the non-AP STAs in a subsequent trigger frame, thereby completing the MU UL transmission.

FIG. 5 is a schematic diagram of a frame format of an NFRP trigger frame. FIG. 6 is a schematic diagram of a format of a common info field in an NFRP trigger frame. A UL bandwidth (BW) field indicates a BW for an NDP feedback report response. A UL space time block code (STBC) field, a low-density parity check code (LDPC) extra symbol segment field, a pre-forward error correction (pre-FEC) padding factor field, a PE disambiguity field, a UL spatial reuse field, and a Doppler field are reserved.

A number of HE-LTF symbols and midamble periodicity field indicates the number of HE-LTF Symbols present in an NDP feedback report response and is set to 1.

A guard interval (GI) and HE-LTF type (GI and HE-LTF type) field is set to 2.

A trigger dependent common info field is not present.

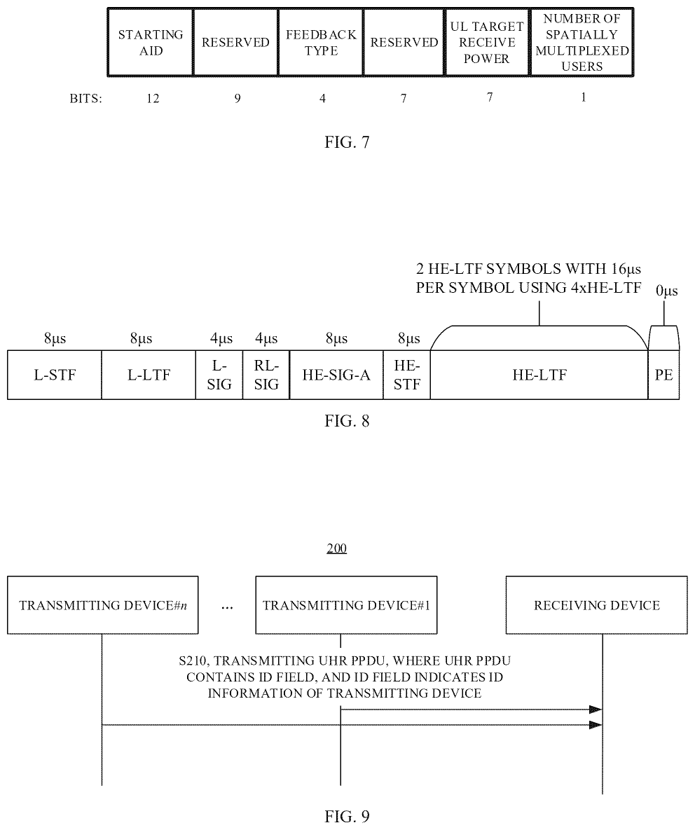

FIG. 7 is a schematic diagram of a format of a user info list field in an NFRP trigger frame. A starting AID field defines the first AID of a range of AIDs that are scheduled to respond to the NFRP trigger frame.

A feedback type field indicates the type of feedback information carried in an HE TB feedback NDP.

A UL target receive power field indicates an expected receive signal power measured at an AP's antenna connector and averaged over the antennas.

A number of spatially multiplexed users field indicates the number of STAs that are multiplexed on the same set of subcarriers in the same resource unit (RU), and is encoded as the number of STAs minus 1.

The BE TB feedback NDP is used for carrying NDP feedback report information. FIG. 8 illustrates a format of an HE TB feedback NDP. A different RU_TONE-SET_INDEX in an BTE-LTF field is used for identifying an AID of a different non-AP STA and feedback information (FEEDBACK_STATUS), and specific correspondences are as illustrated in Table 1.

TABLE 1
Table of HE-LTF subcarrier mapping for an HE TB feedback NDP

| RU_{—} | 80 MHz | | 40 MHz | | 20 MHz | |
|---|---|---|---|---|---|---|
| TONE_{—} | Kₜₒₙₑ_{_{—}}_{NDPu} if | Kₜₒₙₑ_{_{—}}_{NDPu} if | Kₜₒₙₑ_{_{—}}_{NDPu} if | Kₜₒₙₑ_{_{—}}_{NDPu} if | Kₜₒₙₑ_{_{—}}_{NDPu} if | Kₜₒₙₑ_{_{—}}_{NDPu} if |
| SET_{—} | FEEDBACK_{—} | FEEDBACK_{—} | FEEDBACK_{—} | FEEDBACK_{—} | FEEDBACK_{—} | FEEDBACK_{—} |
| INDEX | STATUS is 1 | STATUS is 0 | STATUS is 1 | STATUS is 0 | STATUS is 1 | STATUS is 0 |
| 1 | Use 20 MHz | Use 20 MHz | Use 20 MHz | Use 20 MHz | −113, −77, −41, | −112, −76, −40, |
| | FEEDBACK_{—} | FEEDBACK_{—} | FEEDBACK_{—} | FEEDBACK_{—} | 6, 42, 78 | 7, 43, 79 |
| 2 | STATUS = | STATUS = | STATUS = | STATUS = | −111, −75, −39, | −110, −74, −38, |
| | 1 Subcarrier | 0 Subcarrier | 1 Subcarrier | 0 Subcarrier | 8, 44, 80 | 9, 45, 81 |
| 3 | Indices − 384 | Indices − 384 | Indices − 128 | Indices − 128 | −109, −73, −37, | −108, −72, −36, |
| | | | | | 10, 46, 82 | 11, 47, 83 |
| 4 | | | | | −107, −71, −35, | −106, −70, −34, |
| | | | | | 12, 48, 84 | 13, 49, 85 |
| 5 | | | | | −105, −69, −33, | −104, −68, −32, |
| | | | | | 14, 50, 86 | 15, 51, 87 |
| 6 | | | | | −103, −67, −31, | −102, −66, −30, |
| | | | | | 16, 52, 88 | 17, 53, 89 |
| 7 | | | | | −101, −65, −29, | −100, −64, −28, |
| | | | | | 18, 54, 90 | 19, 55, 91 |
| 8 | | | | | −99, −63, −27, | −98, −62, −26, |
| | | | | | 20, 56, 92 | 21, 57, 93 |
| 9 | | | | | −97, −61, −25, | −96, −60, −24, |
| | | | | | 22, 58, 94 | 23, 59, 95 |
| 10 | | | | | −95, −59, −23, | −94, −58, −22, |
| | | | | | 24, 60, 96 | 25, 61, 97 |
| 11 | | | | | −93, −57, −21, | −92, −56, −20, |
| | | | | | 26, 62, 98 | 27, 63, 99 |
| 12 | | | | | −91, −55, −19, | −90, −54, −18, |
| | | | | | 28, 64, 100 | 29, 65, 101 |
| 13 | | | | | −89, −53, −17, | −88, −52, −16, |
| | | | | | 30, 66, 102 | 31, 67, 103 |
| 14 | | | | | −87, −51, −15, | −86, −50, −14, |
| | | | | | 32, 68, 104 | 33, 69, 105 |
| 15 | | | | | −85, −49, −13, | −84, −48, −12, |
| | | | | | 34, 70, 106 | 35, 71, 107 |
| 16 | | | | | −83, −47, −11, | −82, −46, −10, |
| | | | | | 36, 72, 108 | 37, 73, 109 |
| 17 | | | | | −81, −45, −9, | −80, −44, −8, |
| | | | | | 38, 74, 110 | 39, 75, 111 |
| 18 | | | | | −79, −43, −7, | −78, −42, −6, |
| | | | | | 40, 76, 112 | 41, 77, 113 |
| 19-36 | Use 20 MHz | Use 20 MHz | Use 20 MHz | Use 20 MHz | | |
| | FEEDBACK_{—} | FEEDBACK_{—} | FEEDBACK_{—} | FEEDBACK_{—} | | |
| | STATUS = | STATUS = | STATUS = | STATUS = | | |
| | 1 Subcarrier | 0 Subcarrier | 1 Subcarrier | 0 Subcarrier | | |
| | Indices − 128 | Indices − 128 | Indices + 128 | Indices + 128 | | |
| 37-54 | Use 20 MHz | Use 20 MHz | | | | |
| | FEEDBACK_{—} | FEEDBACK_{—} | | | | |
| | STATUS = | STATUS = | | | | |
| | 1 Subcarrier | 0 Subcarrier | | | | |
| | Indices + 128 | Indices + 128 | | | | |
| 55-72 | Use 20 MHz | Use 20 MHz | | | | |
| | FEEDBACK_{—} | FEEDBACK_{—} | | | | |
| | STATUS = | STATUS = | | | | |
| | 1 Subcarrier | 0 Subcarrier | | | | |
| | Indices + 384 | Indices + 384 | | | | |

RU_TONE_SET_INDEX for 80 + 80 MHz and 160 MHz shall use RU_TONE_SET_INDEX of two 80 MHz.
RU_TONE_SET_INDEX 1-72 are mapped to a lower 80 MHz, and RU_TONE_SET_INDEX 73-144 are mapped to an upper 80 MHz.

Only an HE-LTF field of 4×HE-LTF type can be used in the HE TB feedback NDP, and the following equation needs to be satisfied:

$${HELTF}_{k , u}^{TB \_ NDP} = \{ \begin{matrix}{HELTF}_{k} , & if k ∈ {K}_{{tone}_{{NDP}_{u}}} \\ 0 , & otherwise\end{matrix}$$

where HELTFₖ is a value of a common HE-LTF sequence on subcarrier k, and

$${K}_{{tone}_{{NDP}_{u}}}$$

is an index of a subcarrier(s) having energy on which an HE-LTF field in the HE TB feedback NDP transmitted by user u (also referred to as “STA u”) is positioned, as illustrated in Table 1.

A subcarrier(s) having energy and corresponding to one user forms one subcarrier set, and one subcarrier set can correspond to one subcarrier set index, i.e., RU_TONE_SET_INDEX. For example, the subcarrier set {−113, −77, −41, 6, 42, 78}, the subcarrier set {−112, −76, −40, 7, 43, 79}, etc., in Table 1, each corresponds to one subcarrier set index, i.e., one RU_TONE_SET_INDEX. When the number of spatially multiplexed users field in an NFRP trigger frame is set to 0, each RU_TONE_SET_INDEX corresponds to one non-AP STA (e.g., AID).

When the BW is 20 MHz, for a non-AP STA using RU_TONE_SET_INDEX=1, FEEDBACK_STATUS=1 means that subcarriers −113, −77, −41, 6, 42, and 78 on which the HE-LTF is positioned have energy and other subcarriers have no energy, and FEEDBACK_STATUS=0 means that subcarriers −112, −76, −40, 7, 43, and 79 on which the HE-LTF is positioned have energy and other subcarriers have no energy. When the BW is 40 MHz or 80 MHz, subcarrier mapping for 20 MHz is extended by 1 time and 3 times, respectively, such that more non-AP STAs (AIDs) can be mapped.

When the BW is 40 MHz or 80 MHz, subcarrier mapping for 20 MHz is extended by 1 time and 3 times, respectively, such that more non-AP STAs (AIDs) can be mapped.

For example, when the BW is 40 MHz, for a non-AP STA using RU_TONE_SET_INDEX=1, FEEDBACK_STATUS=1 means that subcarriers −241 (i.e. −113−128), −205 (i.e. −77−128), −169 (i.e. −41−128), −122 (i.e., 6−128), −86 (i.e., 42−128), and −50 (i.e., 78−128) on which the HE-LTF is positioned have energy and other subcarriers have no energy, and FEEDBACK_STATUS=0 means that subcarriers −240 (i.e., −112−128), −204 (i.e., −76−128), −168 (i.e., −40−128), −121 (i.e., 7−128), −85 (i.e., 43−128), and −49 (i.e., 79−128) on which the HE-LTF is positioned have energy and other subcarriers have no energy.

When the number of spatially multiplexed users field in an NFRP trigger frame is set to 1, each RU_TONE_SET_INDEX corresponds to two non-AP STAs (AIDs), and the two non-AP STAs are differentiated according to different pre-assigned precoding matrixes, respectively.

A PE field related to the present disclosure is described below.

A PE field provides additional receive processing time at the end of a PPDU. The PE field (if present) shall be transmitted with the same average power as a data field and shall not cause significant power leakage outside of a spectrum used by the data field. Other than that, the content of the PE field is arbitrary.

In some scenarios, a duration of a PE field in an HE PPDU may be 0 μs, 4 μs, 8 μs, 12 μs, or 16 μs.

In some scenarios, a duration of a PE field in an EHT PPDU may be 0 μs, 4 μs, 8 μs, 12 μs, or 16 μs.

In some scenarios, a PE field with a duration of 20 μs is only used in the following cases: an EHT MU PPDU with at least one participating STA using 4096-quadrature amplitude modulation (QAM); a 320 MHz EHT MU PPDU with one of an allocated RU or multiple RU (MRU) being greater than 2×996 tone; and an EHT TB PPDU.

The duration of the PE field is determined by both a pre-FEC padding factor value in the last orthogonal frequency-division multiplexing (OFDM) symbol(s) of the data field and a TXVECTOR parameter NOMINAL_PACKET_PADDING.

In some scenarios, the method for selecting the duration of the PE field in the HE PPDU and the EHT PPDU can be as illustrated in Table 2 and Table 3.

TABLE 2
Table of HE PE values

| | TXVECTOR parameter NOMINAL_PACKET_PADDING | | |
|---|---|---|---|
| pre-FEC | (HE SU PPDU or HE ER SU PPDU) or | | |
| padding | NOMINAL_PACKET_PADDING[u] (HE MU PPDU) | | |
| factor a | 0 μs | 8 μs | 16 μs |
| 1 | 0 μs | 0 μs | 4 μs |
| 2 | 0 μs | 0 μs | 8 μs |
| 3 | 0 μs | 4 μs | 12 μs |
| 4 | 0 μs | 8 μs | 16 μs |

TABLE 3
Table of EHT PE values

| | TXVECTOR parameter NOMINAL_PACKET_PADDING | | | |
|---|---|---|---|---|
| | (EHT MU PPDU) | | | |
| a | 0 μs | 8 μs | 16 μs | 20 μs |
| 1 | 0 μs | 0 μs | 4 μs | 8 μs |
| 2 | 0 μs | 0 μs | 8 μs | 12 μs |
| 3 | 0 μs | 4 μs | 12 μs | 16 μs |
| 4 | 0 μs | 8 μs | 16 μs | 20 μs |

A pilot subcarrier(s) related to the present disclosure is described below.

In some scenarios, an OFDM symbol may be constructed of multiple subcarriers in the frequency domain, some of the subcarriers are data subcarriers for carrying data, some of the subcarriers are pilot subcarriers for phase and frequency tracking, and some of the subcarriers are unused subcarriers including a DC subcarrier(s), a guard band subcarrier(s), and a null subcarrier(s). The number, position, and content of a pilot subcarrier(s) in an OFDM symbol in an RU of particular size may be predefined.

Taking a 242-tone RU as an example, positions of pilot subcarriers in each 242-tone RU in PPDUs of different BWs can be as illustrated in Table 4 below.

TABLE 4
Positions of pilot subcarriers in 242-tone RU

| PPDU BW | K_{R242i} |
|---|---|
| 20 MHz, i = 1 | {116, 90, 48, 22, 22, 48, 90, 116} |
| 40 MHz, i = 1:2 | {−238, 212, 170, 144, 104, 78, 36, 10}, {10, 36, 78, |
| | 104, 144, 170, 212, 238} |
| 80 MHz, i = 1:4 | (−494, 468, 426, 400, 360, 334, 292, 266}, {252, 226, |
| | 184, 158, 118, 92, 50, 24}, {24, 50, 92, 118, 158, 184, |
| | 226, 252}, {266, 292, 334, 360, 400, 426, 468, 494} |
| 160 MHz, i = 1:8 | {pilot subcarrier indices in 80 MHz − 512, pilot |
| | subcarrier indices in 80 MHz + 512}, i.e., 8 sets of |
| | pilot subcarriers |

For a 242-tone RU, a pilot mapping matrix

$${P}_{n}^{{K}_{R {242}_{i}}}$$

for a pilot subcarrier(s) on the n-th symbol is determined according to Equation (1) below:

$${P}_{n}^{{K}_{R {242}_{i}}} = \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , \} \qquad Equation ( 1 )$$

$${P}_{n}^{k ∉ {K}_{R {242}_{i}}} = 0$$

where mod represents a modulo operation, K_{R242}_{ᵢ} represents a pilot subcarrier in the 242-tone RU, and

$${P}_{n}^{k ∉ {K}_{R {242}_{i}}} = 0$$

represents that for a non-pilot subcarrier(s) in the 242-tone RU, a corresponding pilot mapping matrix takes the value of 0.

For a 484-tone RU, a pilot mapping matrix

$${P}_{n}^{{K}_{R {484}_{i}}}$$

for a subcarrier(s) on the n-th symbol is determined according to Equation (2) below:

$${P}_{n}^{{K}_{R {484}_{i}}} = \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , \} \qquad Equation ( 2 )$$

$${P}_{n}^{k ∉ {K}_{R {484}_{i}}} = 0$$

where mod represents a modulo operation, K_{R484}_{ᵢ} represents a pilot subcarrier in the 484-tone RU, and

$${P}_{n}^{k ∉ {K}_{R {484}_{i}}} = 0$$

represents that for a non-pilot subcarrier(s) in the 484-tone RU, a corresponding pilot mapping matrix takes the value of 0.

For a 996-tone RU, a pilot mapping matrix for a subcarrier(s) on the n-th symbol is determined according to Equation (3) below:

$${P}_{n}^{{K}_{R {996}_{i}}} = \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , \} \qquad Equation ( 3 )$$

$${P}_{n}^{k ∉ {K}_{R {996}_{i}}} = 0$$

where mod represents a modulo operation, K_{R996}_{ᵢ} represents a pilot subcarrier in the 996-tone RU, and

$${P}_{n}^{k ∉ {K}_{R {996}_{i}}} = 0$$

represents that for a non-pilot subcarrier(s) in the 996-tone RU, a corresponding pilot mapping matrix takes the value of 0.

For a 2×996-tone RU, a pilot mapping matrix for a subcarrier(s) on the n-th symbol is determined according to Equation (4) below:

$${P}_{n}^{{K}_{R 2 \times {996}_{i}}} = \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , \} \qquad Equation ( 4 )$$

$${P}_{n}^{k ∉ {K}_{R 2 \times {996}_{i}}} = 0$$

where mod represents a modulo operation, K_{R2×996}_{ᵢ} represents a pilot subcarrier in the 2×996-tone RU, and

$${P}_{n}^{k ∉ {K}_{R 2 \times {996}_{i}}} = 0$$

represents that for a non-pilot subcarrier(s) in the 2×996-tone RU, a corresponding pilot mapping matrix takes the value of 0.

For a 4×996-tone RU, a pilot mapping matrix for a subcarrier(s) on the n-th symbol is determined according to Equation (5) below:

$${P}_{n}^{{K}_{R 4 \times {996}_{i}}} = \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , \} \qquad Equation ( 5 )$$

$${P}_{n}^{k ∉ {K}_{R 4 \times {996}_{i}}} = 0$$

where mod represents a modulo operation, K_{R4×996}_{ᵢ} represents a pilot subcarrier in the 4×996-tone RU, and

$${P}_{n}^{k ∉ {K}_{R 4 \times {996}_{i}}} = 0$$

represents that for a non-pilot subcarrier(s) in the 4×996-tone RU, a corresponding pilot mapping matrix takes the value of 0.

In the Equation, a value of Ψₘ (where m=0, 1, . . . , 7) is predefined. For example, Ψₘ is as defined in Table 5 below:

TABLE 5

| Ψ₀ | Ψ₁ | Ψ₂ | Ψ₃ | Ψ₄ | Ψ₅ | Ψ₆ | Ψ₇ |
|---|---|---|---|---|---|---|---|
| 1 | 1 | 1 | −1 | −1 | 1 | 1 | 1 |

As can be seen from the Equations, a pilot mapping matrix for a pilot subcarrier(s) on each OFDM symbol is different, the subscript of the pilot mapping matrix used is incremented with the increase of the symbol number n, and the subscript of the pilot mapping matrix is used cyclically.

As can be seen from the NDP feedback report mechanism described above, an HE TB feedback NDP must be used in combination with an NFRP trigger frame within a TXOP of an AP, i.e., the MU UL detection function must be completed with the domination by the AP and a non-AP STA can only cooperate passively. As such, a timing for using the MU UL detection function is limited. If the AP cannot compete for the TXOP in time or the TXOP is occupied by another non-AP STA or AP, the MU UL detection cannot be completed in time. As a result, MU UL transmission cannot be performed in time, leading to a large delay jitter of an average delay to UL services.

Therefore, there is room for improvement in the method for MU detection.

In order for better understanding of the technical solutions of embodiments of the present disclosure, the technical solutions of the present disclosure will be described in detail below in connection with specific embodiments. The following related art, as an optional scheme, can be arbitrarily combined with the technical solutions of embodiments of the present disclosure, which shall all belong to the protection scope of embodiments of the present disclosure. Embodiments of the present disclosure include at least some of the following.

FIG. 9 is a schematic diagram illustrating an interaction of a method for wireless communication 200 according to embodiments of the present disclosure. As illustrated in FIG. 9, the method 200 includes the following.

At S210, one or more transmitting devices (e.g., transmitting device #1, transmitting device #2, . . . , transmitting device #n) each transmit an ultra-high reliability (UHR) PPDU. The UHR PPDU contains an identifier (ID) field. The ID field indicates ID information (or referred to as “identity information”) of the transmitting device (e.g., an AID, a UID, or a medium access control (MAC) address of the transmitting device) of the UHR PPDU, or the ID field is used by a receiving device to identify the transmitting device.

Correspondingly, the receiving device can receive the UHR PPDU(s) transmitted by the one or more transmitting devices, and identify a transmitting device of each of the one or more UHR PPDUs according to the ID field in the UHR PPDU.

Therefore, in embodiments of the present disclosure, the receiving device identifies the transmitting device of the UHR PPDU according to the ID field in the UHR PPDU received, i.e., the receiving device identifies the transmitting device at a PHY

In some embodiments, the UHR PPDU can be used in MU detection scenarios, or the ID field is used for MU detection.

For example, in the MU detection scenarios, a receiving device can identify a transmitting device according to an ID field in a UHR PPDU transmitted by the transmitting device, such that the receiving device can know that the transmitting device has a transmission requirement. That is, the receiving device can identify or detect a UHR PDDU of a different transmitting device according to the ID field.

In some embodiments, the transmitting device may be an AP device, and the receiving device may be an STA device.

That is, embodiments of the present disclosure may be used for UL MU detection. That is, the AP device can identify or detect a different STA device according to the ID field.

For example, in UL MU detection scenarios, the STA device can transmit a UHR PPDU to the AP device, where the UHR PPDU contains an ID field, and the ID field indicates ID information of the STA device. The AP device can identify the STA device by parsing the UHR PPDU, and thus can know that the STA device has a UL transmission requirement. Further, the AP device can allocate resources for the STA device with a UL transmission requirement, thereby completing the MU UL transmission.

In some embodiments, the transmitting device may be an STA device, and the receiving device may be an AP device.

That is, embodiments of the present disclosure may be used for DL MU detection. That is, the STA device can identify or detect a different AP device according to the ID field.

For example, in DL MU detection scenarios, the AP device can transmit a UHR PPDU to the STA device, where the UHR PPDU contains an ID field, and the ID field indicates ID information of the AP device. The STA device can identify the AP device by parsing the UHR PPDU, and thus can know that the AP device has a DL transmission requirement.

In some embodiments, the UHR PPDU may be a PPDU for carrying data to be transmitted.

That is, the transmitting device can indicate its ID information by carrying an ID field in the PPDU carrying data to be transmitted, thereby implementing MU detection.

Correspondingly, the receiving device can implement MU detection by receiving the ID field in the PPDU (which may be a UL PPDU or a DL PPDU) carrying the data to be transmitted. Therefore, in the case that the receiving device does not obtain a TXOP, the receiving device can also implement MU detection by receiving the PPDU carrying the data. In this way, application timing and scenarios of MU detection can be expanded, thereby improving the flexibility of MU detection, and allowing the function of MU detection to be implemented in different scenarios.

In some embodiments, the ID field is an optional field.

For example, in the MU detection scenarios, the ID field may be carried in the UHR PPDU transmitted by the transmitting device, and in other scenarios where the receiving device is not required to identify the identity of the transmitting device, the ID field may not be carried in the UHR PPDU.

For another example, in the case where the MU detection can be implemented based on the UHR PPDU carrying the ID field, the ID field is carried in the UHR PPDU, otherwise, the ID field is not carried in the UHR PPDU.

In some embodiments, a duration of the ID field is a fixed value. For example, the duration of the ID field may be an integer value greater than 0, such as 12 μs, 16 μs, 20 μs, 24 μs, 28 μs, 32 μs, etc.

In some embodiments, the duration of the ID field is variable. For example, the duration of the ID field is indicated in another field in the UHR PPDU.

In some embodiments, an average power for transmitting the ID field is the same as an average power for transmitting a data field in the UHR PPDU. That is, the ID field needs to be transmitted with the same average power as the data field.

In some embodiments, the power for transmitting the ID field shall not cause significant power leakage outside of a spectrum used by the data field.

In some embodiments, the ID field may explicitly indicate the ID information of the transmitting device. For example, the ID field may carry an AID, a UID, or an MAC address of the transmitting device or another ID that can be used for identifying the identity of the transmitting device.

In some other embodiments, the ID field may implicitly indicate the ID information of the transmitting device. For example, a resource(s) for transmitting the ID field implicitly indicates the ID information of the transmitting device. Specifically, for example, a subcarrier(s) for transmitting the ID field indicates the ID information of the transmitting device.

In some embodiments, there is a correspondence between a subcarrier set for transmitting the ID field and the ID information of the transmitting device, or there is a correspondence between the transmitting device and the subcarrier set for transmitting the ID field. Thus, the transmitting device can indicate the ID information of the transmitting device through the subcarrier set for transmitting the ID field. Correspondingly, the receiving device can determine the ID information of the transmitting device according to a subcarrier set for receiving the ID field. For example, the receiving device can determine the transmitting device that transmitted the ID field by detecting which subcarriers have energy for the ID field in the UHR PPDU and/or values on the subcarriers having energy.

In some embodiments, the subcarrier set can be indicated through RU_TONE_SET_INDEX, and each RU_TONE_SET_INDEX corresponds to ID information, such as an AID, of one transmitting device.

In some embodiments, a correspondence between the ID information of the transmitting device and the subcarrier set is predefined.

In some embodiments, the number of subcarriers that can be contained in one subcarrier set is greater than 1 and does not exceed the total number of subcarriers.

It can be understood that, the present disclosure does not limit the number of subcarrier sets corresponding to the transmitting device. For example, one transmitting device may correspond to one subcarrier set, or may correspond to multiple subcarrier sets, e.g., two subcarrier sets.

Optionally, when one transmitting device corresponds to multiple subcarrier sets, the ID field transmitted through a different subcarrier set among the multiple subcarrier sets can indicate different state information of the transmitting device. Therefore, when the transmitting device corresponds to the multiple subcarrier sets, the subcarrier set for transmitting the ID field can further indicate state information of the transmitting device in addition to the ID information of the transmitting device.

In some specific embodiments, a first transmitting device corresponds to a first subcarrier set (corresponding to state 0) and a second subcarrier set (corresponding to state 1), and a second transmitting device corresponds to a third subcarrier set (corresponding to state 0) and a fourth subcarrier set (corresponding to state 1).

If the receiving device detects that the first subcarrier set has energy for the ID field, it can be determined that the first transmitting device transmits a UHR PPDU carrying the ID field and the state of the first transmitting device is state 0. Alternatively, if the receiving device detects that the second subcarrier set has energy for the ID field, it can be determined that the first transmitting device transmits the UHR PPDU carrying the ID field and the state of the first transmitting device is state 1. Alternatively, if the receiving device detects that the third subcarrier set has energy for the ID field, it can be determined that the second transmitting device transmits the UHR PPDU carrying the ID field and the state of the second transmitting device is state 0. Alternatively, if the receiving device detects that the fourth subcarrier set has energy for the ID field, it can be determined that the second transmitting device transmits the UHR PPDU carrying the ID field and the state of the second transmitting device is state 1.

In other specific embodiments, a first transmitting device corresponds to a first subcarrier set, a second transmitting device corresponds to a second subcarrier set, a third transmitting device corresponds to a third subcarrier set, and a fourth transmitting device corresponds to a fourth subcarrier set. If the receiving device detects that the first subcarrier set has energy for the ID field, it can be determined that the first transmitting device transmits a UHR PPDU carrying the ID field. Alternatively, if the receiving device detects that the second subcarrier set has energy for the ID field, it can be determined that the second transmitting device transmits the UHR PPDU carrying the ID field. Alternatively, if the receiving device detects that the third subcarrier set has energy, it can be determined that the third transmitting device transmits the UHR PPDU carrying the ID field. Alternatively, if the receiving device detects that the fourth subcarrier set has energy for the ID field, it can be determined that the fourth transmitting device transmits the UHR PPDU carrying the ID field.

In some embodiments, the UHR PPDU may contain a PE field, or may not contain a PE field.

In a specific embodiment, the UHR PPDU contains a PE field, and the ID field is positioned before the PE field.

In another specific embodiment, the UHR PPDU does not contain a PE field, and the ID field is positioned at a tail of the UHR PPDU.

Optionally, when the UHR PPDU contains the PE field, the PE field can provide additional processing time for the receiving device. When the UHR PPDU does not contain the PE field, the ID field can provide additional processing time for the receiving device.

In some embodiments, the UHR PPDU further contains a reverse interval field, and the reverse interval field is used for reserving an interval for the receiving device of the UHR PPDU to reverse from a receiving state to a transmitting state.

In some embodiments, the reverse interval field can be positioned before the ID field.

In some embodiments, a duration of the reverse interval field is variable. For example, a signal, e.g., random data, may be transmitted in the reverse interval field, or no signal may be transmitted in the reverse interval field, which is not limited in the present disclosure.

In some embodiments, the reverse interval field can be present when the UHR PPDU contains the ID field. For example, when the duration of the ID field is 0, the duration of the reverse interval field is also 0. When the duration of the ID field is greater than 0, the duration of the reverse interval field is also greater than 0.

Optionally, in the duration reserved by the reverse interval field, the receiving device switches from the receiving state to the transmitting state, and transmits an ID field carrying ID information of the receiving device, allowing other receiving devices to identify the receiving device. Optionally, the ID field transmitted by the receiving device is aligned in time with the ID field transmitted by the transmitting device. For example, during the reverse interval, the receiving device can switch from the receiving state to the transmitting state, and then simultaneously transmit an ID field aligned with the ID field transmitted by the transmitting device to indicate the ID information of the receiving device. In this case, the role of the receiving device switches to a transmitting device.

It can be noted that, in the UHR PPDU, the ID field and the reverse interval field may be independent fields. For example, the ID field and the reverse interval field may be fields at the same level as existing fields in the UHR PPDU. Alternatively, the reverse interval field may be a subfield in the ID field. The present disclosure does not specifically limit the positions and levels of the ID field and the reverse interval field in the UHR PPDU. The following format design is illustrated with an example that the ID field and the reverse interval field are independent fields, which is not limited in the present disclosure.

It can be noted that, the name of the ID field is not specifically limited in the present disclosure. For example, the ID field may also be referred to as “identity field”, “user identity field”, “user ID field”, “user identifying extended (UIE) field”, etc. The following format design is illustrated by taking the UIE field as an example, which is not limited in the present disclosure.

It can also be noted that, the name of the reverse interval field is not limited in the present disclosure, and the reverse interval field may have other similar names, such as “reverse time field”, “reserved interval field”, “reserved time field”, etc.

In Embodiment 1, a format design of a UHR PPDU carrying an ID field is elaborated below.

### Embodiment 1

In some embodiments, an ID field may be newly added into an existing UHR PPDU to indicate the ID information of the transmitting device of the UHR PPDU, or a new UHR PPDU carrying an ID field may be defined for MU detection, which is not limited in the present disclosure.

In some embodiments, an existing field in the UHR PPDU may be used as the ID field, e.g., a reserved field in the UHR PPDU is used as the ID field, or a new field may be added into the UHR PPDU as the ID field, which is not limited in the present disclosure.

It can be noted that, the present disclosure does not limit the position of the ID field in the UHR PPDU, as long as the transmitting device and the receiving device have a consistent understanding of the position of the ID field in the UHR PPDU. For example, the ID field may be carried at the end of the UHR PPDU, may be carried before a PE field in the UHR PPDU, may be carried before or after an existing field in the UHR PPDU, etc.

In some embodiments, the UHR PPDU may be a UHR MU PPDU, a UHR TB PPDU, or a UHR extended range (ER) PPDU. For example, an ID field is newly added into the UHR MU PPDU, the UHR TB PPDU, or the UHR ER PPDU to indicate the ID information of the transmitting device of the UHR PPDU.

It can be noted that, in embodiments of the present disclosure, the UHR MU PPDU, the UHR TB PPDU, or the UHR ER PPDU carrying the ID field may also be referred to as a UHR MU PPDU, a UHR TB PPDU, or a UHR ER PPDU, or the UHR MU PPDU, the UHR TB PPDU, or the UHR ER PPDU carrying the ID field may be renamed, which is not limited in the present disclosure. In the following, description is given with an example that the UHR MU PPDU, the UHR TB PPDU, or the UHR ER PPDU carrying the ID field is still referred to as a UHR MU PPDU, a UHR TB PPDU, or a UHR ER PPDU, which is not limited in the present disclosure.

Embodiment 1-1: the UHR PPDU contains an ID field and does not contain a PE field, where the ID field is carried at the end of the UHR PPDU.

In Embodiment 1-1, it can be considered that, the ID field has both the function of identifying the transmitting device (in other words, the function of identifying MU identity) and the function of the PE field, i.e., for increasing the processing time for the receiving device.

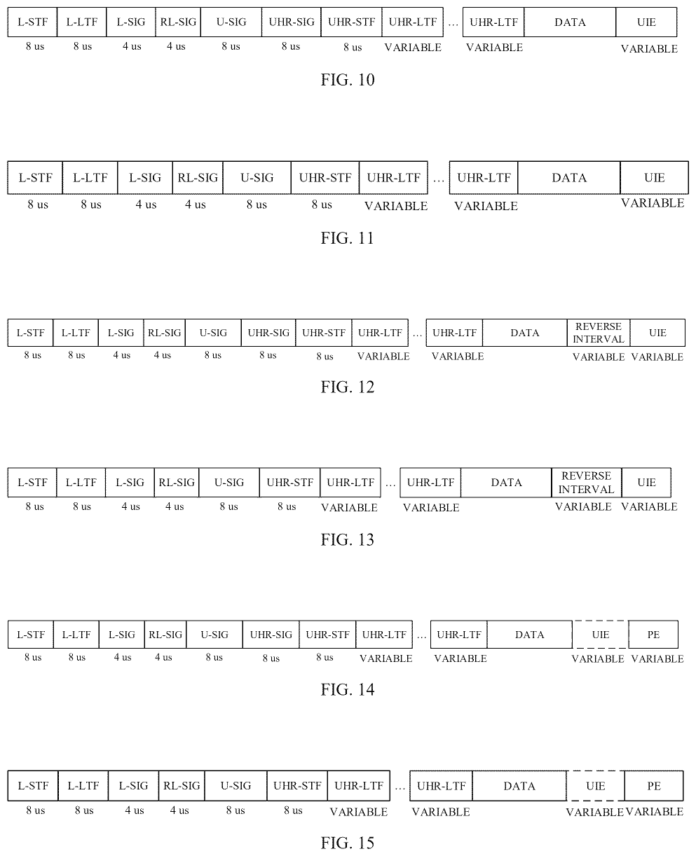

FIG. 10 is a schematic diagram of a format of a UHR MU PPDU or a UHR ER PPDU carrying an ID field according to embodiments of the present disclosure. The UHR MU PPDU or the UHR ER PPDU does not contain a PE field, and the ID field is carried at the end of the UHR MU PPDU or the UHR ER PPDU. The ID field has both the function of identifying the transmitting device (in other words, the function of identifying MU identity) and the function of the PE field, i.e., for increasing the processing time for the receiving device.

As illustrated in FIG. 10, the UHR MU PPDU or the UHR ER PPDU may further contain the following fields: an L-STF, an L-LTF, an L-SIG, an RL-SIG, a U-SIG, a UHR-SIG, a UHR-STF, a UHR-LTF, and a data field. The L-STF is used for PPDU discovery and initial time-frequency synchronization. The L-LTF is used for initial channel estimation and further time-frequency alignment. The L-SIG is used for carrying information required for parsing a PPDU. The RL-SIG is a repetition of an L-SIG. The U-SIG is used for carrying information required for parsing a PPDU. The UHR-SIG is used for carrying information related to DL MU transmission. The UHR-STF is used for assisting a receiving device to perform initial time-frequency synchronization and to detect the reliability of a PE field. The UHR-LTF is used by a receiving device for channel estimation. The data field is used for carrying data.

FIG. 11 is a schematic diagram of a format of a UHR TB PPDU carrying an ID field according to embodiments of the present disclosure. The UHR TB PPDU may not contain a PE field, and the ID field is carried at the end of the UHR TB PPDU. In this case, the ID field has both the function of identifying the transmitting device (in other words, the function of identifying MU identity) and the function of the PE field, i.e., for increasing the processing time for the receiving device.

It can be understood that, the PPDU format illustrated in FIG. 11 differs from the PPDU format illustrated in FIG. 10 in that the PPDU format illustrated in FIG. 11 does not contain a UHR-SIG field, and the meanings of other fields are similar to the meanings of corresponding fields in the format illustrated in FIG. 10, which will not be repeated herein for brevity.

Embodiment 1-2: the UHR PPDU contains an ID field and a reverse interval field, and does not contain a PE field, where the ID field is carried at the end of the UHR PPDU, and the reverse interval field is positioned before the ID field.

In Embodiment 1-2, it can be considered that, the ID field has both the function of identifying the transmitting device (in other words, the function of identifying MU identity) and the function of the PE field, i.e., for increasing the processing time for the receiving device. The reverse interval field is used for reserving an interval for the receiving device to reverse from a receiving state to a transmitting state.

FIG. 12 is a schematic diagram of a format of a UHR MU PPDU or a UHR ER PPDU carrying an ID field and a reverse interval field according to embodiments of the present disclosure. The UHR MU PPDU or the UHR ER PPDU does not contain a PE field, the ID field is carried at the end of the UHR MU PPDU or the UHR ER PPDU, and the reverse interval field is positioned before the ID field.

In this example, the ID field has both the function of identifying the transmitting device (in other words, the function of identifying MU identity) and the function of the PE field, i.e., for increasing the processing time for the receiving device. The reverse interval field is used for reserving an interval for the receiving device to reverse from the receiving state to the transmitting state.

It can be understood that, the PPDU format illustrated in FIG. 12 differs from the PPDU format illustrated in FIG. 10 in that the PPDU format illustrated in FIG. 12 contains a reverse interval field and the PPDU format illustrated in FIG. 10 does not contain a reverse interval field. For the meaning of another field other than the ID field and the reverse interval field illustrated in FIG. 12, reference may be made to the description of the corresponding field in the PPDU format illustrated in FIG. 10, which will not be repeated herein for brevity.

FIG. 13 is a schematic diagram of a format of a UHR TB PPDU carrying an ID field and a reverse interval field according to embodiments of the present disclosure. The UHR TB PPDU does not contain a PE field, the ID field is carried at the end of the UHR MU PPDU or the UHR ER PPDU, and the reverse interval field is positioned before the ID field. In this example, the ID field has both the function of identifying the transmitting device (in other words, the function of identifying MU identity) and the function of the PE field, i.e., for increasing the processing time for the receiving device. The reverse interval field is used for reserving an interval for the receiving device to reverse from the receiving state to the transmitting state.

It can be understood that, the PPDU format illustrated in FIG. 13 differs from the PPDU format illustrated in FIG. 11 in that the PPDU format illustrated in FIG. 13 contains a reverse interval field and the PPDU format illustrated in FIG. 11 does not contain a reverse interval field. For the meaning of another field other than the ID field and the reverse interval field illustrated in FIG. 13, reference may be made to the description of the corresponding field in the PPDU format illustrated in FIG. 10, which will not be repeated herein for brevity.

Optionally, in Embodiment 1-2, in the duration reserved by the reverse interval field, the receiving device switches from the receiving state to the transmitting state, and transmits an ID field carrying ID information of the receiving device, allowing other receiving devices to identify the receiving device. Optionally, the ID field transmitted by the receiving device is aligned in time with the ID field transmitted by the transmitting device.

Embodiment 1-3: the UHR PPDU contains an ID field and a PE field, where the PE field is carried at the end of the UHR PPDU, and the ID field is positioned before the PE field.

In Embodiment 1-3, the ID field has the function of identifying the transmitting device (in other words, the function of identifying MU identity), and the PE field is used for increasing the processing time for the receiving device.

FIG. 14 is a schematic diagram of a format of another UHR MU PPDU or UHR ER PPDU carrying an ID field according to embodiments of the present disclosure. The UHR MU PPDU or the UHR ER PPDU contains a PE field, the PE field is carried at the end of the UHR MU PPDU or the UHR ER PPDU, and the ID field is positioned before the PE field. The ID field has the function of identifying the transmitting device (in other words, the function of identifying MU identity), and the PE field is used for increasing the processing time for the receiving device.

It can be understood that, the PPDU format illustrated in FIG. 14 differs from the PPDU format illustrated in FIG. 10 in that the PPDU format illustrated in FIG. 14 contains a PE field and the PPDU format illustrated in FIG. 10 does not contain a PE field. For the meaning of another field other than the ID field illustrated in FIG. 14, reference may be made to the description of the corresponding field in the PPDU format illustrated in FIG. 10, which will not be repeated herein for brevity.

FIG. 15 is a schematic diagram of a format of another UHR TB PPDU carrying an ID field according to embodiments of the present disclosure. The UHR TB PPDU contains a PE field, the PE field is carried at the end of the UHR MU PPDU or the UHR ER PPDU, and the ID field is positioned before the PE field.

It can be understood that, the PPDU format illustrated in FIG. 15 differs from the PPDU format illustrated in FIG. 11 in that the PPDU format illustrated in FIG. 15 contains a PE field and the PPDU format illustrated in FIG. 11 does not contain a PE field. For the meaning of another field other than the ID field illustrated in FIG. 15, reference may be made to the description of the corresponding field in the PPDU format illustrated in FIG. 10, which will not be repeated herein for brevity.

Embodiment 1-4: the UHR PPDU contains an ID field, a reverse interval field, and a PE field, where the PE field is carried at the end of the UHR PPDU, the ID field is positioned before the PE field, and the reverse interval field is positioned before the ID field.

In Embodiment 1-4, the ID field has the function of identifying the transmitting device (in other words, the function of identifying MU identity), the PE field is used for increasing the processing time for the receiving device, and the reverse interval field is used for reserving an interval for the receiving device to reverse from the receiving state to the transmitting state.

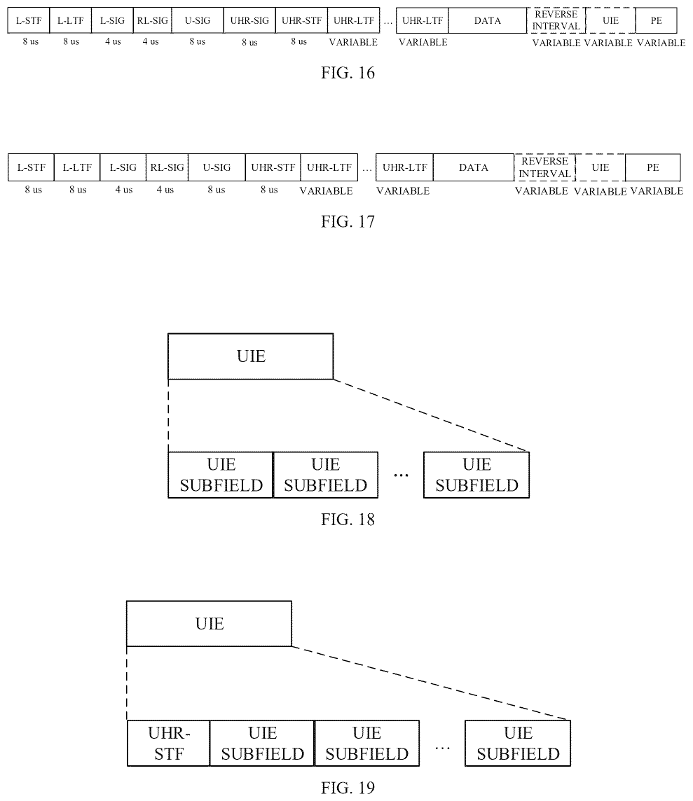

FIG. 16 is a schematic diagram of a format of another UHR MU PPDU or UHR ER PPDU carrying an ID field and a reverse interval field according to embodiments of the present disclosure. The UHR MU PPDU or the UHR ER PPDU contains a PE field, the PE field is positioned at the end of the UHR MU PPDU or the UHR ER PPDU, and the ID field and the reverse interval field are carried before the PE field. The ID field has the function of identifying the transmitting device (in other words, the function of identifying MU identity), the PE field is used for increasing the processing time for the receiving device, and the reverse interval field is used for reserving an interval for the receiving device to reverse from the receiving state to the transmitting state.

It can be understood that, the PPDU format illustrated in FIG. 16 differs from the PPDU format illustrated in FIG. 13 in that the PPDU format illustrated in FIG. 16 contains a PE field and the PPDU format illustrated in FIG. 13 does not contain a PE field. For the meaning of another field other than the ID field and the reverse interval field illustrated in FIG. 16, reference may be made to the description of the corresponding field in the PPDU format illustrated in FIG. 10, which will not be repeated herein for brevity.

FIG. 17 is a schematic diagram of a format of another UHR TB PPDU carrying an ID field and a reverse interval field according to embodiments of the present disclosure. The UHR TB PPDU contains a PE field, the PE field is positioned at the end of the UHR MU PPDU or the UHR ER PPDU, and the ID field and the reverse interval field are carried before the PE field.

It can be understood that, the PPDU format illustrated in FIG. 17 differs from the PPDU format illustrated in FIG. 13 in that the PPDU format illustrated in FIG. 17 contains a PE field and the PPDU format illustrated in FIG. 13 does not contain a PE field. For the meaning of another field other than the ID field and the reverse interval field illustrated in FIG. 17, reference may be made to the description of the corresponding field in the PPDU format illustrated in FIG. 10, which will not be repeated herein for brevity.

It can be noted that, the UHR PPDU formats illustrated in FIG. 10 to FIG. 17 are exemplified only with an example that a duration of the UIE field is a variable duration, which is not limited in the present disclosure. Alternatively, the duration of the UIE field may be a fixed duration. Similarly, a duration of the reverse interval field may be a fixed duration, which is not limited in the present disclosure.

In Embodiment 2, a format design of an ID field in a UHR PPDU is described below.

### Embodiment 2

In some embodiments of the present disclosure, the ID field contains one or more ID subfields, and the one or more ID subfields indicate the ID information of the transmitting device.

In some embodiments, a subcarrier used for the one or more ID subfields indicates the ID information of the transmitting device.

In some embodiments, when the ID field contains multiple ID subfields, the multiple ID subfields may indicate ID information of one transmitting device. For example, one transmitting device can transmit different ID subfields by using the same subcarrier set, so as to improve transmission reliability. In this case, all the multiple ID subfields indicate the ID information of the transmitting device.

In some embodiments, when the ID field contains multiple ID subfields, the multiple ID subfields may indicate ID information of different transmitting devices. For example, one transmitting device transmits one ID subfield, and a subcarrier used for the transmitting device to transmit the ID subfield indicates ID information of the transmitting device. In other words, the multiple ID subfields can be transmitted by using different subcarrier sets, such that the ID field can allow more users to transmit ID subfields, thereby implementing MU detection.

In some embodiments, the ID field may only contain one or more ID subfields.

In some other embodiments, the ID field may contain some fields, such as a UHR-STF, a UHR-LTF, etc., in a UHR modulated field, and/or some or all fields, such as an L-STF, an L-LTF, an L-SIG, an RL-SIG, a U-SIG, a UHR-SIG, etc., in a pre-UHR modulated field.

In some embodiments, the UHR modulation field may contain a UHR-STF, one or more UHR-LTFs, a data field, and a PE field (if present).

In some embodiments, the pre-UHR modulated field may contain an L-STF, an L-LTF, an L-SIG, an RL-SIG, and a U-SIG.

For example, for a UHR TB PPDU, the pre-UHR modulated field may contain an L-STF, an L-LTF, an L-SIG, an RL-SIG, and a U-SIG.

In some embodiments, the pre-UHR modulated field may contain an L-STF, an L-LTF, an L-SIG, an RL-SIG, a U-SIG, and a UHR-SIG.

For example, for a UHR MU PPDU or a UHR ER PPDU, the pre-UHR modulated field may contain an L-STF, an L-LTF, an L-SIG, an RL-SIG, a U-SIG, and a UHR-SIG.

In some embodiments, a duration of the ID subfield is a fixed value. For example, the duration of the ID subfield may be an integer value greater than 0, such as 12 μs, 16 μs, 20 μs, 24 μs, 28 μs, 32 μs, etc.

In some embodiments, the duration of the ID subfield is variable. For example, the duration of the ID field is indicated in another field in the UHR PPDU.

In some embodiments, an average power for transmitting the ID subfield is the same as an average power for transmitting a data field in the UHR PPDU. That is, the ID subfield needs to be transmitted with the same average power as the data field.

In some embodiments, the power for transmitting the ID subfield shall not cause significant power leakage outside of a spectrum used by the data field.

It can be noted that, the name of the ID subfield is not specifically limited in the present disclosure. For example, the ID subfield may also be referred to as “identity subfield”, “user identity subfield”, “user ID subfield”, “UIE subfield”, etc. The following format design is illustrated by taking the UIE subfield as an example, which is not limited in the present disclosure.

Embodiment 2-1: the ID field only contains one or more ID subfields.

In Embodiment 2-1, the one or more ID subfields are used for identifying the identity of the transmitting device.

FIG. 18 is a schematic diagram of a format of an ID field according to embodiments of the present disclosure. As illustrated in FIG. 18, the ID field only contains one or more ID subfields and carries no other fields, which is conducive to reducing the overhead of the UHR PPDU.

In some embodiments, a subcarrier used for transmitting the ID subfield indicates ID information, such as an AID, a UID, an MAC address, etc., of a transmitting device transmitting the ID subfield.

In some embodiments, when the ID field contains multiple ID subfields, the multiple ID subfields may indicate ID information of a same transmitting device. For example, one transmitting device can transmit the multiple ID subfields by using the same subcarrier set, so as to improve the transmission reliability. In this case, all the multiple ID subfields indicate the transmitting device. Alternatively, the multiple ID subfields may indicate ID information of different transmitting devices, i.e., different ID subfields may be transmitted by different transmitting devices. For example, different transmitting devices transmit corresponding ID subfields by using different subcarrier sets, which is equivalent to increasing the number of user IDs that can be carried in an ID field.

Embodiment 2-2: the ID field contains one or more ID subfields and a UHR-STF.

In Embodiment 2-2, the one or more ID subfields are used for identifying the identity of the transmitting device. The UHR-STF is used for assisting the receiving device in performing initial time-frequency synchronization and AGC, and is used for assisting the receiving device in detecting the reliability of a PE field (in the case where the PE field is present).

FIG. 19 is a schematic diagram of a format of another ID field according to embodiments of the present disclosure. As illustrated in FIG. 19, the ID field contains one or more ID subfields and one UHR-STF. The one or more ID subfields are used for identifying the identity of the transmitting device. The UHR-STF is used for assisting the receiving device in performing initial time-frequency synchronization and AGC, and in the case where a PE field is present, the UHR-STF is used for assisting the receiving device in detecting the reliability of the PE field.

Therefore, based on the format design of the ID field in Embodiment 2-2, the receiving device can implement user identity identification and AGC, which is conducive to improving the success rate of MU detection.

Embodiment 2-3: the ID field contains a UHR-STF, one or more UHR-LTFs, and one or more ID subfields.

In Embodiment 2-3, the one or more ID subfields are used by the receiving device to identify the transmitting device at a PHY The UHR-STF is used for assisting the receiving device in performing initial time-frequency synchronization and AGC, and is used for assisting the receiving device in detecting the reliability of a PE field (in the case where the PE field is present). The UHR-LTF is used for channel estimation and is used for assisting the receiving device in performing fine time-frequency synchronization.

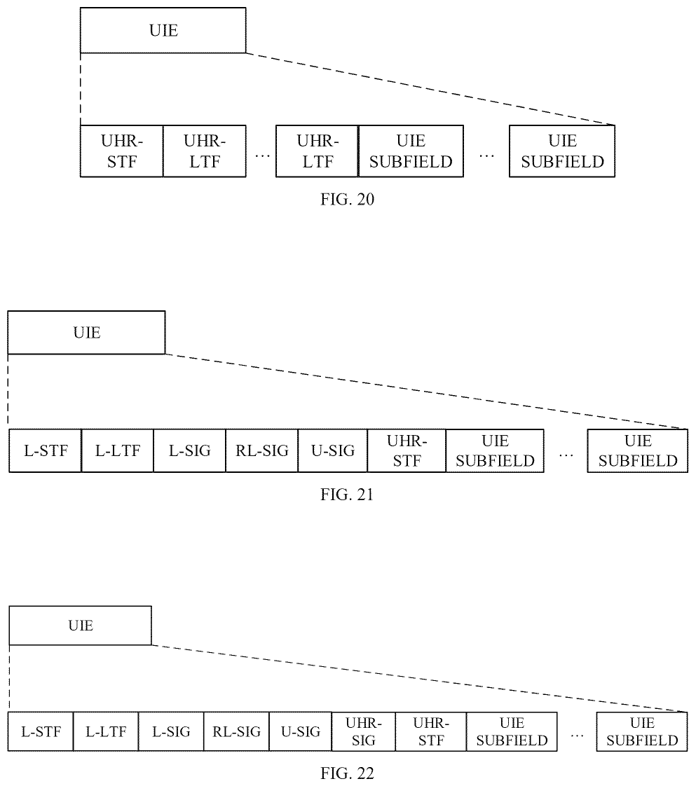

FIG. 20 is a schematic diagram of a format of yet another ID field according to embodiments of the present disclosure. As illustrated in FIG. 20, the ID field contains one UHR-STF, one or more UHR-LTFs, and one or more ID subfields.

The one or more ID subfields are used for identifying the identity of the transmitting device. The UHR-STF is used for assisting the receiving device in performing initial time-frequency synchronization and AGC, and in the case where a PE field is present, the UHR-STF is used for assisting the receiving device in detecting the reliability of the PE field. The UHR-LTF is used for channel estimation and is used for assisting the receiving device in performing fine time-frequency synchronization.

Therefore, based on the format design of the ID field in Embodiment 2-3, the receiving device can implement user identity identification, AGC, and channel estimation, which is conducive to improving the success rate of MU detection.

Embodiment 2-4: the ID field contains an L-STF, an L-LTF, an L-SIG, an RL-SIG, a U-SIG, a UHR-STF, and one or more ID subfields. That is, the ID field contains an entire pre-UHR modulated field in a UHR TB PPDU, or the ID field contains an entire UHR evolved version of an HE TB feedback NDP, i.e., an L-STF, an L-LTF, an L-SIG, an RL-SIG, and a U-SIG.

FIG. 21 is a schematic diagram of a format of yet another ID field according to embodiments of the present disclosure. As illustrated in FIG. 21, the ID field contains an L-STF, an L-LTF, an L-SIG, an RL-SIG, a U-SIG, a UHR-STF, and one or more ID subfields. Each field has the following function. The ID subfield is used for identifying an identity of a transmitting device. The L-STF is used for PPDU discovery and initial time-frequency synchronization. The L-LTF is used for initial channel estimation and further time-frequency alignment. The L-SIG is used for carrying information required for parsing a PPDU. The RL-SIG is a repetition of an L-SIG. The U-SIG is used for carrying information required for parsing a PPDU. The UHR-STF is used for assisting a receiving device to perform initial time-frequency synchronization and AGC, and is used for assisting a receiving device to detect the reliability of a PE field.

Therefore, the ID field in Embodiment 2-4 is equivalent to containing an entire NDP, which is not only conducive to improving the success rate of MU detection, but is also easy to implement because the format of the ID field is a common PPDU format.

Embodiment 2-5: the ID field contains an L-STF, an L-LTF, an L-SIG, an RL-SIG, a U-SIG, a UHR-SIG, a UHR-STF, and one or more ID subfields. That is, the ID field contains an entire pre-UHR modulated field in a UHR MU PPDU or a UHR ER PPDU, or the ID field contains an entire UHR evolved version of an EHT NDP, i.e., an L-STF, an L-LTF, an L-SIG, an RL-SIG, a U-SIG, a UHR-SIG.

FIG. 22 is a schematic diagram of a format of yet another ID field according to embodiments of the present disclosure. As illustrated in FIG. 22, the ID field contains an L-STF, an L-LTF, an L-SIG, an RL-SIG, a U-SIG, a UHR-SIG, a UHR-STF, and one or more ID subfields. Each field has the following function. The ID subfield is used for identifying an identity of a transmitting device. The L-STF is used for PPDU discovery and initial time-frequency synchronization. The L-LTF is used for initial channel estimation and further time-frequency alignment. The L-SIG is used for carrying information required for parsing a PPDU. The RL-SIG is a repetition of an L-SIG. The U-SIG is used for carrying information required for parsing a PPDU. The UHR-SIG is used for carrying information related to DL MU transmission. The UHR-STF is used for assisting a receiving device to perform initial time-frequency synchronization and AGC, and is used for assisting a receiving device to detect the reliability of a PE field.

Therefore, the ID field in Embodiment 2-5 is equivalent to containing an entire NDP, which is not only conducive to improving the success rate of MU detection, but is also easy to implement because the format of the ID field is a common PPDU format.

It can be noted that, the design of the UHR PPDU in Embodiment 1 may be implemented alone, or may be implemented in combination with the format design of the ID field in Embodiment 2.

In some embodiments, the ID field in the UHR PPDU in Embodiment 1-1 and Embodiment 1-3 can adopt the format design of the ID field in Embodiment 2-1. For example, the ID field in the UHR PPDU illustrated in FIG. 10, FIG. 11, FIG. 14, and FIG. 15 can only contain one or more ID subfields.

In some embodiments, the ID field in the UHR PPDU in Embodiment 1-1, Embodiment 1-2, Embodiment 1-3, and Embodiment 1-4 can adopt the format design of the ID field in Embodiment 2-2. For example, the ID field in the UHR PPDU illustrated in FIG. 10 to FIG. 17 can contain one or more ID subfields and one UHR-STF.

In some embodiments, the ID field in the UHR PPDU in Embodiment 1-1, Embodiment 1-2, Embodiment 1-3, and Embodiment 1-4 can adopt the format design of the ID field in Embodiment 2-3. For example, the ID field in the UHR PPDU illustrated in FIG. 10 to FIG. 17 can contain one UHR-STF, one or more UHR-LTFs, and one or more ID subfields.

In some embodiments, the ID field in the UHR PPDU in Embodiment 1-2 and Embodiment 1-4 can adopt the format design of the ID field in Embodiment 2-4.

In some embodiments, the ID field in the UHR PPDU in Embodiment 1-2 and Embodiment 1-4 can adopt the format design of the ID field in Embodiment 2-5. For example, the ID field in the UHR PPDU illustrated in FIG. 12, FIG. 13, FIG. 16, and FIG. 17 can only contain one or more ID subfields.

A UHR PPDU carrying a reverse interval field can support a device receiving the UHR PPDU to complete TX/RX transition and separately transmit a UIE field during a reverse interval. To improve the probability of successful reception of the separately transmitted UIE field, some midamble can be carried in the UIE field, such that a format design of the UIE carrying midamble is applicable to the UIE field in the UHR PPDU in Embodiment 1-2 and Embodiment 1-4.

In Embodiment 3, a design of an ID subfield is described below.

In some embodiments, the ID subfield may explicitly indicate the ID information of the transmitting device. For example, the ID subfield may carry an AID, a UID, or an MAC address of the transmitting device or another ID that can be used for identifying the identity of the transmitting device.

In some other embodiments, the ID subfield may implicitly indicate the ID information of the transmitting device. For example, a resource(s) for transmitting the ID subfield implicitly indicates the ID information of the transmitting device. Specifically, for example, a subcarrier(s) for transmitting the ID subfield indicates the ID information of the transmitting device.

In some embodiments, there is a correspondence between a subcarrier set for transmitting the ID subfield and the ID information of the transmitting device, or there is a correspondence between the transmitting device and the subcarrier set for transmitting the ID subfield. Thus, the transmitting device can indicate the ID information of the transmitting device through the subcarrier set for transmitting the ID subfield. Correspondingly, the receiving device can determine the ID information of the transmitting device according to a subcarrier set for receiving the ID subfield. For example, the receiving device can determine the transmitting device that transmitted the ID subfield by detecting which subcarriers have energy for the ID subfield in the UHR PPDU and/or values on the subcarriers having energy.

In some embodiments, the subcarrier set can be indicated through RU_TONE_SET_INDEX, and each RU_TONE_SET_INDEX corresponds to ID information, such as an AID, of one transmitting device.

In some embodiments, a correspondence between the ID information of the transmitting device and the subcarrier set is predefined.

In some embodiments, one subcarrier set may contain multiple subcarriers.

It can be understood that, the present disclosure does not limit the number of subcarrier sets corresponding to the transmitting device. For example, one transmitting device may correspond to one subcarrier set, or may correspond to multiple subcarrier sets, e.g., two subcarrier sets.

Optionally, when one transmitting device corresponds to multiple subcarrier sets, the ID field transmitted through a different subcarrier set among the multiple subcarrier sets can indicate different state information of the transmitting device. Therefore, when the transmitting device corresponds to the multiple subcarrier sets, the subcarrier set for transmitting the ID field can further indicate state information of the transmitting device in addition to the ID information of the transmitting device.

The following describes a specific implementation of the ID subfield indicating the ID information of the transmitting device, in conjunction with specific embodiments.

Embodiment 3-1: one transmitting device corresponds to two subcarrier sets, or one transmitting device is identified through two subcarrier sets.

In some embodiments, the two subcarrier sets corresponding to the transmitting device are used for identifying different state information of the transmitting device, respectively.

In some specific embodiments, a first transmitting device corresponds to a first subcarrier set (corresponding to state 0) and a second subcarrier set (corresponding to state 1), and a second transmitting device corresponds to a third subcarrier set (corresponding to state 0) and a fourth subcarrier set (corresponding to state 1).

If the receiving device detects that the first subcarrier set has energy for the ID subfield, it can be determined that the transmitting device is the first transmitting device and the state of the first transmitting device is state 0. Alternatively, if the receiving device detects that the second subcarrier set has energy for the ID subfield, it can be determined that the transmitting device is the first transmitting device and the state of the first transmitting device is state 1. Alternatively, if the receiving device detects that the third subcarrier set has energy for the ID subfield, it can be determined that the transmitting device is the second transmitting device and the state of the second transmitting device is state 0. Alternatively, if the receiving device detects that the fourth subcarrier set has energy for the ID subfield, it can be determined that the transmitting device is the second transmitting device and the state of the second transmitting device is state 1.

It can be understood that, the present disclosure does not limit a BW for the ID subfield. For example, the ID subfield has a maximum BW of 160 MHz or 320 MHz. Specifically, for example, the BW for the ID subfield may be 20 MHz, 40 MHz, 80 MHz, 80+80 MHz, 160 MHz, or 320 MHz.

In some embodiments, when the BW for the ID subfield is 20 MHz, 40 MHz, 80 MHz, 80+80 MHz, or 160 MHz, the correspondence between the subcarrier set and the transmitting device can be as illustrated in Table 1.

For example, when the BW for the ID subfield is 20 MHz, if the receiving device detects that subcarriers −113, −77, −41, 6, 42, and 78 have energy for the ID subfield and other subcarriers have no energy, it can be determined that the transmitting device is a device corresponding to RU_TONE_SET_INDEX=1. Alternatively, if the receiving device detects that subcarriers −111, −75, −39, 8, 44, and 80 have energy for the ID subfield and other subcarriers have no energy, it can be determined that the transmitting device is a device corresponding to RU_TONE_SET_INDEX=2.

For another example, when the BW for the ID subfield is 40 MHz, if the receiving device detects that subcarriers −241, −205, −169, −122, −86, and −50 have energy for the ID subfield and other subcarriers have no energy, it can be determined that the transmitting device is a device corresponding to RU_TONE_SET_INDEX=1. Alternatively, if the receiving device detects that the that the ID subfield has energy on subcarriers −240, −204, −168, −121, −85, and −49 have energy for the ID subfield and other subcarriers have no energy, it can be determined that the transmitting device is a device corresponding to RU_TONE_SET_INDEX=2.

In some embodiments, when the BW for the ID subfield is 320 MHz, the 320 MHz can be represented by subcarrier set indices (i.e., RU-TONE-SET-INDEX) of four 80 MHz, where RU-TONE-SET-INDEX 1-72 are mapped to a first 80 MHz (i.e., the lowest 80 MHz), RU-TONE-SET-INDEX 73-144 are mapped to a second 80 MHz, RU-TONE-SET-INDEX 145-216 are mapped to a third 80 MHz, and RU-TONE-SET-INDEX 217-288 are mapped to a fourth 80 MHz (i.e., the highest 80 MHz).

Embodiment 3-2: one transmitting device can correspond to one subcarrier set, or one transmitting device is identified through one subcarrier set. Compared with Embodiment 3-1, in Embodiment 3-2, a greater number of transmitting devices can be indicated with the same number of subcarrier sets.

In some embodiments, a first transmitting device corresponds to a first subcarrier set, a second transmitting device corresponds to a second subcarrier set, a third transmitting device corresponds to a third subcarrier set, and a fourth transmitting device corresponds to a fourth subcarrier set. If the receiving device detects that the first subcarrier set has energy for an ID subfield, it can be determined that a transmitting device for the ID subfield is the first transmitting device. Alternatively, if the receiving device detects that the second subcarrier set has energy for an ID subfield, it can be determined that a transmitting device for the ID subfield is the second transmitting device. Alternatively, if the receiving device detects that the third subcarrier set has energy for an ID subfield, it can be determined that a transmitting device for the ID subfield is the third transmitting device. Alternatively, if the receiving device detects that the fourth subcarrier set has energy for an ID subfield, it can be determined that a transmitting device for the ID subfield is the fourth transmitting device.

It can be understood that, the present disclosure does not limit the BW for the ID subfield. For example, the ID subfield has a maximum BW of 160 MHz or 320 MHz. Specifically, for example, the BW for the ID subfield may be 20 MHz, 40 MHz, 80 MHz, 80+80 MHz, 160 MHz, or 320 MHz.

In some embodiments, the correspondence between the subcarrier set and the transmitting device can be as illustrated in Table 1.

In some specific embodiments, when the BW for the ID subfield is 20 MHz, 40 MHz, 80 MHz, 80+80 MHz, 160 MHz, or 320 MHz, if one subcarrier set contains six subcarriers, the correspondence between the subcarrier set and the transmitting device can be as illustrated in Table 6.

TABLE 6

| RU_{—} | | | |
|---|---|---|---|
| TONE_{—} | | | |
| SET_{—} | | | |
| INDEX | 80 MHz | 40 MHz | 20 MHz |
| 1 | Use 20 MHz | Use 20 MHz | −113, −77, −41, 6, 42, 78 |
| 2 | Subcarrier | Subcarrier | −112, −76, −40, 7, 43, 79 |
| 3 | Indices −384 | Indices −128 | −111, −75, −39, 8, 44, 80 |
| 4 | | | −110, −74, −38, 9, 45, 81 |
| 5 | | | −109, −73, −37, 10, 46, 82 |
| 6 | | | −108, −72, −36, 11, 47, 83 |
| 7 | | | −107, −71, −35, 12, 48, 84 |
| 8 | | | −106, −70, −34, 13, 49, 85 |
| 9 | | | −105, −69, −33, 14, 50, 86 |
| 10 | | | −104, −68, −32, 15, 51, 87 |
| 11 | | | −103, −67, −31, 16, 52, 88 |
| 12 | | | −102, −66, −30, 17, 53, 89 |
| 13 | | | −101, −65, −29, 18, 54, 90 |
| 14 | | | −100, −64, −28, 19, 55, 91 |
| 15 | | | −99, −63, −27, 20, 56, 92 |
| 16 | | | −98, −62, −26, 21, 57, 93 |
| 17 | | | −97, −61, −25, 22, 58, 94 |
| 18 | | | −96, −60, −24, 23, 59, 95 |
| 19 | | | −95, −59, −23, 24, 60, 96 |
| 20 | | | −94, −58, −22, 25, 61, 97 |
| 21 | | | −93, −57, −21, 26, 62, 98 |
| 22 | | | −92, −56, −20, 27, 63, 99 |
| 23 | | | −91, −55, −19, 28, 64, 100 |
| 24 | | | −90, −54, −18, 29, 65, 101 |
| 25 | | | −89, −53, −17, 30, 66, 102 |
| 26 | | | −88, −52, −16, 31, 67, 103 |
| 27 | | | −87, −51, −15, 32, 68, 104 |
| 28 | | | −86, −50, −14, 33, 69, 105 |
| 29 | | | −85, −49, −13, 34, 70, 106 |
| 30 | | | −84, −48, −12, 35, 71, 107 |
| 31 | | | −83, −47, −11, 36, 72, 108 |
| 32 | | | −82, −46, −10, 37, 73, 109 |
| 33 | | | −81, −45, −9, 38, 74, 110 |
| 34 | | | −80, −44, −8, 39, 75, 111 |
| 35 | | | −79, −43, −7, 40, 76, 112 |
| 36 | | | −78, −42, −6, 41, 77, 113 |
| 37-72 | Use 20 MHz | Use 20 MHz | |
| | Subcarrier | Subcarrier | |
| | Indices −128 | Indices +128 | |
| 73-108 | Use 20 MHz | | |
| | Subcarrier | | |
| | Indices +128 | | |
| 108-143 | Use 20 MHz | | |
| | Subcarrier | | |
| | Indices +384 | | |

RU_TONE_SET_INDEX for 80 + 80 MHz and 160 MHz uses the 80 MHz RU_TONE_SET_INDEX definition. RU_TONE_SET_INDEX values 1-143 are mapped to the lower 80 MHz, and RU_TONE_SET_INDEX values 144-285 are mapped to the upper 80 MHz.
RU_TONE_SET_INDEX for 320 MHz shall use the 80 MHz RU_TONE_SET_INDEX definition for the four 80 MHz. RU_TONE_SET_INDEX values 1-143 are mapped to the first 80 MHz, RU_TONE_SET_INDEX values 144-285 are mapped to the second 80 MHz, RU_TONE_SET_INDEX values 286-428 are mapped to the third 80 MHz, and RU_TONE_SET_INDEX values 429-571 are mapped to the fourth 80 MHz.

Based on the correspondences in Table 6, when the BW for the ID subfield is 20 MHz, if the receiving device detects that subcarriers −113, −77, −41, 6, 42, and 78 have energy for the ID subfield and other subcarriers have no energy, it can be determined that the transmitting device is a device corresponding to RU_TONE_SET_INDEX=1. Alternatively, if the receiving device detects that subcarriers −112, −76, −40, 7, 43, and 79 have energy for the ID subfield and other subcarriers have no energy, it can be determined that the transmitting device is a device corresponding to RU_TONE_SET_INDEX=2. When the BW is 40 MHz or 80 MHz, subcarrier mapping for 20 MHz is extended by 1 time and 3 times, respectively, such that more users can be mapped. For example, when the BW for the ID subfield is 20 MHz, if the receiving device detects that subcarriers −113, −77, −41, 6, 42, and 78 have energy for the ID subfield and other subcarriers have no energy, it can be determined that the transmitting device is a device corresponding to RU_TONE_SET_INDEX=1. Alternatively, if the receiving device detects that subcarriers −111, −75, −39, 8, 44, and 80 have energy for the ID subfield and other subcarriers have no energy, it can be determined that the transmitting device is a device corresponding to RU_TONE_SET_INDEX=2.

It can be understood that, the various embodiments in Embodiment 3 and the various embodiments in Embodiment 2 can be implemented in combination. For example, the ID subfield in Embodiment 2-1, Embodiment 2-2, Embodiment 2-3, Embodiment 2-4, and Embodiment 2-5 may adopt the design in Embodiment 3-1, or may adopt the design in Embodiment 3-2.

In some embodiments of the present disclosure, the UHR PPDU can further carry control information of the ID field, for example, whether the UHR PPDU contains an ID field, configuration information of the ID field, etc.

In some embodiments, the configuration information of the ID field includes at least one of: the number of ID subfields contained in the ID field, usage or type of the ID field, or the number of users that are multiplexed on one set of subcarriers (or one subcarrier set) in a same RU.

In some embodiments, the usage or type of the ID field can include, but is not limited to, only MU identification (or MU detection) and both MU identification and increasing the processing time for the receiving device.

In some embodiments, the number of users that are multiplexed on one set of subcarriers (or one subcarrier set) in the same RU can refer to the number of users that are multiplexed on the same subcarrier set in the same RU.

In some embodiments of the present disclosure, an existing field in the UHR PPDU may be used for carrying control information of the ID field. For example, a reserved field in the UHR PPDU may be used for carrying the control information of the ID field. Alternatively, a new field may be added into the UHR PPDU for carrying the control information of the ID field, which is not limited in the present disclosure.

In some embodiments, the UHR PPDU can contain a control field, and the control field indicates whether the UHR PPDU contains the ID field and/or the configuration information of the ID field.

In some embodiments, the control field may be implemented using an existing field in the UHR PPDU, for example, may be implemented using a reserved field, or may be implemented by adding a new field in the UHR PPDU.

In some embodiments, the control field contains, but is not limited to, at least one of the following fields: an ID present (e.g., UIE present) field, a first number field, a usage field (or referred to as “type field”), or a second number field. The ID present field indicates whether an ID field and/or a reverse interval field are present in a UHR PPDU. The first number field indicates the number of ID subfields contained in an ID field. The usage field indicates the usage or type of an ID field. The second number field indicates the number of users that are multiplexed on one set of subcarriers in a same RU.

In some embodiments, the ID present field indicates whether an ID field and/or a reverse interval field are present in a UHR PPDU.

In some embodiments, the ID present field may be 1 bit.

For a specific example, a value of the ID present field being 1 indicates present, and the value of the ID present field being 0 indicates not present.

For another specific example, the value of the ID present field being 0 indicates present, and the value of the ID present field being 1 indicates not present.

In some other embodiments, the ID present field can also indicate whether the end of the UHR PPDU is an ID field or a PE field.

For example, the value of the ID present field being 1 indicates that the end of the UHR PPDU is an ID field, and the value of the ID present field being 0 indicates that the end of the UHR PPDU is a PE field.

For another example, the value of the ID present field being 0 indicates that the end of the UHR PPDU is an ID field, and the value of the ID present field being 1 indicates that the end of the UHR PPDU is a PE field.

Optionally, for Embodiment 1-1 and Embodiment 1-2, when the ID present field indicates that the end of the UHR PPDU is a PE field, it can be considered that the UHR PPDU does not contain an ID field, and when the ID present field indicates that the end of the UHR PPDU is an ID field, it can be considered that the UHR PPDU contains an ID field.

In some embodiments, the first number field may be 1 bit, 2 bits, or more bits. For example, the number of bits occupied by the first number field may be determined by the maximum number of ID subfields that can be carried in the ID field, or may be determined by the number of types of the number of ID subfields that can be carried in the ID field.

For example, if the ID field can carry up to four ID subfields, the first number field may be 2 bits.

For another example, if the ID field can carry two ID subfields or four ID subfields, the first number field may be 1 bit, indicating the two types of numbers respectively. For example, a value of the first number field being 1 indicates carrying two ID subfields, and the value of the first number field being 0 indicates carrying four ID subfields. Alternatively, the value of the first number field being 1 indicates carrying four ID subfields, and the value of the first number field being 0 indicates carrying two ID subfields.

In some embodiments, the usage field may be 1 bit, 2 bits, or more bits. For example, the number of bits occupied by the usage field may be determined by the maximum number of usages of the ID field. For example, if the usage of the ID field includes only MU identification (or MU detection) and both MU identification and increasing the processing time for the receiving device, the usage field may be 1 bit.

In some embodiments, the second number field may be 1 bit, 2 bits, or more bits. For example, the number of bits occupied by the second number field may be determined by the maximum number of users that can be multiplexed on the same subcarrier set in the same RU.

For example, if the maximum number of devices that can be multiplexed on the same subcarrier set in the same RU is 4, the second number field may be 2 bits.

For another example, if the maximum number of devices that can be multiplexed on the same subcarrier set in the same RU is 2, the second number field may be 1 bit.

In Embodiment 4, the following describes a specific manner of carrying the control information of the ID field.

Embodiment 4-1: the UHR PPDU contains a U-SIG field, and the control information of the ID field is carried in the U-SIG field.

In some embodiments, the UHR PPDU contains a U-SIG field, the U-SIG field contains a control field, and the control field can contain at least one of an ID present field, a first number field, a usage field, or a second number field.

In some other embodiments, the UHR PPDU contains a U-SIG field, and the U-SIG field contains at least one of an ID present field, a first number field, a usage field, or a second number field.

In Embodiment 4-1, the UHR PPDU may be a UHR MU PPDU, a UHR TB PPDU, or a UHR ER PPDU.

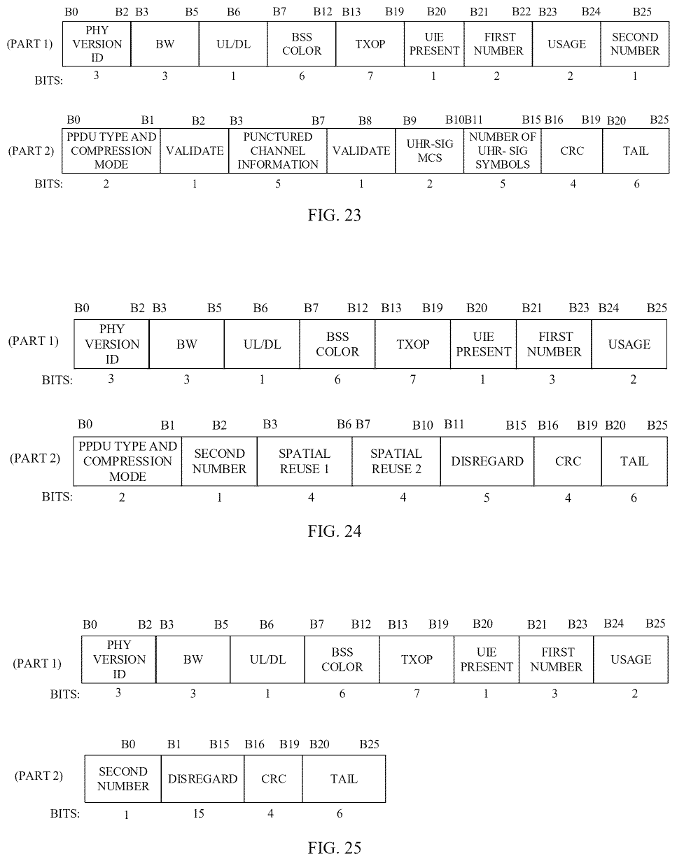

FIG. 23 is a schematic diagram of a format of a UHR MU PPDU with control information of an ID field carried in a U-SIG field according to embodiments of the present disclosure. As illustrated in FIG. 23, the U-SIG field contains the following fields: an ID present field, a first number field, a usage field (or referred to as “type field”), and a second number field. The ID present field indicates whether an ID field and/or a reverse interval field are present in a UHR PPDU. The first number field indicates the number of ID subfields contained in an ID field. The usage field indicates the usage or type of an ID field. The second number field indicates the number of devices that are multiplexed on one set of subcarriers in a same RU.

In some embodiments, the U-SIG field further contains the following fields: a PHY version ID, a BW, a UL/DL, a TXOP, a validate, a PPDU type and compression mode, a punctured channel information, a UHR-SIG modulation and coding scheme (MCS), a number of UHR-SIG symbols, a cyclical redundancy check (CRC), and a tail. The PHY version ID indicates a different PHY version. The BW indicates a BW for a PPDU. The UL/DL indicates whether a PPDU is transmitted in an UL or DL direction. The TXOP indicates duration information of a TXOP and a value of a network allocation vector (NAV). The validate is a reserved field for validation. The PPDU type and compression mode indicates the type of a PPDU. The punctured channel information indicates a set position and mode of PPDU punching. The UHR-SIG MCS indicates a modulation and coding mode of a UHR-SIG field. The number of UHR-SIG symbols indicates the number of symbols in a UHR-SIG field. The CRC indicates a check code for performing CRC on B0-B41 in a U-SIG field. The tail is a field used for terminating the grid of a convolutional decoder.

FIG. 24 is a schematic diagram of a format of a UHR TB PPDU with control information of an ID field carried in a U-SIG field according to embodiments of the present disclosure. As illustrated in FIG. 24, the U-SIG field contains the following fields: an ID present field, a first number field, a usage field (or referred to as “type field”), and a second number field. The ID present field indicates whether an ID field and/or a reverse interval field are present in a UHR PPDU. The first number field indicates the number of ID subfields contained in an ID field. The usage field indicates the usage or type of an ID field. The second number field indicates the number of devices that are multiplexed on one set of subcarriers in a same RU.

In some embodiments, the U-SIG field further contains the following fields: a PHY version ID, a BW, a UL/DL, a TXOP, a disregard, a validate, a PPDU type and compression mode, a spatial reuse 1, a spatial reuse 2, a CRC, and a tail. The PHY version ID indicates a different PHY version. The BW indicates a BW for a PPDU. The UL/DL indicates whether a PPDU is transmitted in an UL or DL direction. The TXOP indicates duration information of a TXOP and a value of an NAV. The disregard is a reserved field indicating disregard. The validate is a reserved field for validation. The PPDU type and compression mode indicates the type of a PPDU. The spatial reuse 1 indicates whether PSR spatial reuse is enabled within a sub-band of a PPDU during transmission of the PPDU, and if enabled, a value of the spatial reuse 1 is used for determining the transmission power limit of a PSRT PPDU. The spatial reuse 2 indicates whether PSR spatial reuse is enabled within a sub-band of a PPDU during transmission of the PPDU, and if enabled, a value of the spatial reuse 2 is used for determining the transmission power limit of a PSRT PPDU. The CRC indicates a check code for performing CRC on B0-B41 in a U-SIG field. The tail is a field used for terminating the grid of a convolutional decoder.

FIG. 25 is a schematic diagram of a format of a UHR ER PPDU with control information of an ID field carried in a U-SIG field according to embodiments of the present disclosure. As illustrated in FIG. 25, the U-SIG field contains the following fields: an ID present field, a first number field, a usage field (or referred to as “type field”), or a second number field. The ID present field indicates whether an ID field and/or a reverse interval field are present in a UHR PPDU. The first number field indicates the number of ID subfields contained in an ID field. The usage field indicates the usage or type of an ID field. The second number field indicates the number of devices that are multiplexed on one set of subcarriers in a same RU.

In some embodiments, the U-SIG field further contains the following fields: a PHY version ID, a BW, a UL/DL, a TXOP, a disregard, a validate, a CRC, and a tail. The PHY version ID indicates a different PHY version. The BW indicates a BW for a PPDU. The UL/DL indicates whether a PPDU is transmitted in an UL or DL direction. The TXOP indicates duration information of a TXOP and a value of an NAV. The disregard is a reserved field indicating disregard. The validate is a reserved field for validation. The CRC indicates a check code for performing CRC on B0-B41 in a U-SIG field. The tail is a field used for terminating the grid of a convolutional decoder.

It can be understood that, for the specific implementation of the ID present field, the first number field, the usage field, and the second number field, reference may be made to related descriptions in the foregoing embodiments, which will not be repeated herein for the sake of brevity.

It can be noted that, the number of bits occupied by the ID present field, the first number field, the usage field, and the second number field and their positions in the U-SIG field are only examples, which is not limited in the present disclosure. For example, the usage field may be 1 bit, the usage field may be positioned before the first number field, etc.

Embodiment 4-2: the UHR PPDU contains a UHR-SIG field, and the control information of the ID field is carried in the UHR-SIG field.

In some embodiments, the UHR PPDU contains a UHR-SIG field, the UHR-SIG field contains a control field, and the control field can contain at least one of an ID present field, a first number field, a usage field, or a second number field.

In some other embodiments, the UHR PPDU contains a UHR-SIG field, and the UHR-SIG field contains at least one of an ID present field, a first number field, a usage field, or a second number field.

In some embodiments, the UHR-SIG field contains a common field and a user specific field, and the control information of the ID field may be carried in the common field or may be carried in the user specific field.

In Embodiment 4-2, the UHR PPDU may be a UHR MU PPDU.

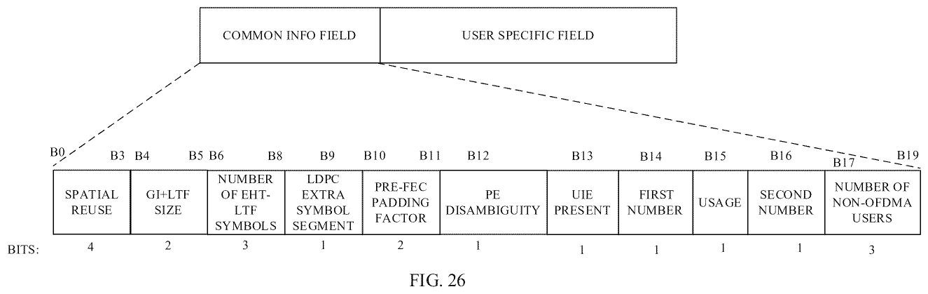

FIG. 26 is a schematic diagram of a format of a UHR MU PPDU with control information of an ID field carried in a common field in a UHR-SIG field according to embodiments of the present disclosure. As illustrated in FIG. 26, the common field in the UHR-SIG field contains the following fields: an ID present field, a first number field, a usage field (or referred to as “type field”), or a second number field. The ID present field indicates whether an ID field and/or a reverse interval field are present in a UHR PPDU. The first number field indicates the number of ID subfields contained in an ID field. The usage field indicates the usage or type of an ID field. The second number field indicates the number of devices that are multiplexed on one set of subcarriers in a same RU.

In some embodiments, as illustrated in FIG. 26, the common field in the UHR-SIG field further contains the following fields: a spatial reuse, a GI+LTF size, a number of UHR-LTF symbols, an LDPC extra symbol segment, a pre-FEC padding factor, a PE disambiguity, and a number of non-OFDMA users. The spatial reuse indicates whether a spatial reuse mode is enabled during the transmission of a PPDU. The GI+LTF size indicates a duration of a GI and the type of a UHR-LTF. The number of UHR-LTF symbols indicates the number of UHR-LTF symbols. The LDPC extra symbol segment indicates whether an LDPC extra symbol segment is present. The pre-FEC padding factor indicates a value of a pre-FEC padding factor. The PE disambiguity indicates a value of a PE disambiguity. The number of non-OFDMA users indicates the number of all non-OFDMA users.

Embodiment 4-3: whether the UHR PPDU contains an ID field is indicated implicitly.

In some embodiments, the UHR PPDU contains two repeated UHR-STFs, and the two repeated UHR-STFs indicate that the UHR PPDU contains the ID field.

Embodiment 4-4: an ID symbol is used to indicate that the UHR PPDU contains an ID field.

In some embodiments, the ID symbol is carried in a pre-UHR modulated field in the UHR PPDU, or may be carried in a UHR modulated field in the UHR PPDU.

In some embodiments, the ID symbol is carried in a first field in the UHR PPDU, and the first field can contain at least one of the following fields: an L-SIG, an RL-SIG, a UHR-STF, a UHR-LTF, a U-SIG, a UHR-SIG, or a data field.

The ID symbol is carried in the pre-UHR modulated field, such that the receiving device can know, as early as possible, that the UHR PPDU contains the ID field, and thus state switching can be performed during the reverse interval. In this way, the receiving device can transmit an ID field or an ID subfield that is aligned with an ID field or an ID subfield transmitted by the transmitting device.

It can be understood that, there may be one or more ID symbols used for identifying that the UHR PPDU contains the ID field, which is not limited in the present disclosure.

In some embodiments, a pilot mapping matrix for a subcarrier(s) on the ID symbol indicates that the UHR PPDU contains the ID field.

For example, when the pilot mapping matrix for the subcarrier(s) on the ID symbol is determined in a first manner, it indicates that the UHR PPDU contains the ID field. When the pilot mapping matrix for the subcarrier(s) on the ID symbol is determined in a second manner, it indicates that the UHR PPDU does not contain the ID field. The first manner is different from the second manner, and a pilot mapping matrix for a subcarrier(s) on a non-ID symbol(s) is determined in the second manner.

In some embodiments, the second manner may be a predefined manner. For example, the pilot mapping matrix determined in the second manner may include the pilot mapping matrix determined based on Equation (1) to Equation (5). That is, the second manner may be the manner illustrated in Equation (1) to Equation (5).

For example, when a pilot mapping matrix for a subcarrier(s) on one symbol occupied by the first field in the UHR PPDU is determined in a non-predefined manner, the symbol can be considered to be an ID symbol, i.e., the UHR PPDU contains the ID field.

Correspondingly, the receiving device can determine whether the UHR PPDU contains the ID field by detecting whether the pilot mapping matrix for the subcarrier(s) on the symbol occupied by the first field in the UHR PPDU is determined in a predefined manner. For example, when the pilot mapping matrix for the subcarrier(s) on the symbol occupied by the first field is different from a pilot mapping matrix determined in a predefined manner, it can be considered that the UHR PPDU contains the ID field, otherwise, it can be determined that the UHR PPDU does not contain the ID field.

In connection with specific embodiments, a manner of determining the pilot mapping matrix for the subcarrier(s) on the ID symbol is described below.

It can be noted that, the manner of calculating the pilot mapping matrix for the subcarrier(s) on the ID symbol exemplified below is only an example, which is not limited in the present disclosure, as long as it is ensured that the pilot mapping matrix for the subcarrier on the ID symbol is different from the pilot mapping matrix determined in the predefined manner and that the identification function can be implemented.

Manner 1: the pilot mapping matrix for the subcarrier(s) on the ID symbol is determined to be a first pilot mapping matrix in the first manner, the pilot mapping matrix for the subcarrier(s) on the ID symbol is determined to be a second pilot mapping matrix in the second manner, and a value of an element in the first pilot mapping matrix is an opposite number of a value of a corresponding element in the second pilot mapping matrix.

That is, the transmitting device can indicate that the UHR PPDU contains the ID field by setting a value of a pilot mapping matrix for a subcarrier(s) on one symbol to an opposite number of a value of a pilot mapping matrix determined in the predefined manner.

Correspondingly, when a value of a pilot mapping matrix for a subcarrier(s) on one symbol is an opposite number of a value of a pilot mapping matrix determined in the predefined manner, the receiving device can determine that the UHR PPDU contains the ID field.

In some embodiments, for a 242-tone RU, a pilot mapping matrix for a subcarrier(s) on ID symbol n determined in the second manner includes: a pilot mapping matrix for the subcarrier(s) on the ID symbol n determined according to Equation (1).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R {242}_{i}}} = ( - 1 ) \times \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , \}$$

$${M}_{n}^{k ∉ {K}_{R {242}_{i}}} = 0$$

$$where {M}_{n}^{{K}_{R {242}_{i}}}$$

represents a pilot mapping matrix corresponding to a subcarrier set K_{R242}_{ᵢ} determined in the first manner, K_{R242}_{ᵢ} represents a pilot subcarrier in the 242-tone RU, and

$${M}_{n}^{k ∉ {K}_{R {242}_{i}}} = 0$$

represents that for a non-pilot subcarrier(s) in the 242-tone RU, a corresponding pilot mapping matrix takes the value of 0.

In some embodiments, for a 484-tone RU, a pilot mapping matrix for a subcarrier(s) on ID symbol n determined in the second manner includes: a pilot mapping matrix for the subcarrier(s) on the ID symbol n determined according to Equation (2).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R {484}_{i}}} = ( - 1 ) \times \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , \}$$

$${M}_{n}^{k ∉ {K}_{R {484}_{i}}} = 0$$

$$where {M}_{n}^{{K}_{R {484}_{i}}}$$

represents a pilot mapping matrix corresponding to a subcarrier set K_{R484}_{₁} determined in the first manner, and

$${M}_{n}^{k ∉ {K}_{R {484}_{i}}} = 0$$

represents that for a non-pilot subcarrier(s) in the 484-tone RU, a corresponding pilot mapping matrix takes the value of 0.

In some embodiments, for a 996-tone RU, a pilot mapping matrix for a subcarrier(s) on ID symbol n determined in the second manner includes: a pilot mapping matrix for the subcarrier(s) on the ID symbol n determined according to Equation (3).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R {996}_{i}}} = ( - 1 ) \times \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , \}$$

$${M}_{n}^{k ∉ {K}_{R {996}_{i}}} = 0$$

$$where {M}_{n}^{{K}_{R {996}_{i}}}$$

represents a pilot mapping matrix corresponding to a subcarrier set K_{R996}_{ᵢ} determined in the first manner, and

$${M}_{n}^{k ∉ {K}_{R {996}_{i}}} = 0$$

represents that for a non-pilot subcarrier(s) in the 996-tone RU, a corresponding pilot mapping matrix takes the value of 0.

In some embodiments, for a 2×996-tone RU, a pilot mapping matrix for a subcarrier(s) on ID symbol n determined in the second manner includes: a pilot mapping matrix for the subcarrier(s) on the ID symbol n determined according to Equation (4).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R 2 \times {996}_{i}}} = ( - 1 ) \times \{ {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , \}$$

$${M}_{n}^{k ∉ {K}_{R 2 \times {996}_{i}}} = 0$$

$$where {M}_{n}^{{K}_{R 2 \times {996}_{i}}}$$

represents a pilot mapping matrix corresponding to a subcarrier set K_{R2×996}_{ᵢ} determined in the first manner, and

$${M}_{n}^{k ∉ {K}_{R 2 \times {996}_{i}}} = 0$$

represents that for a non-pilot subcarrier(s) in the 2×996-tone RU, a corresponding pilot mapping matrix takes the value of 0.

In some embodiments, for a 4×996-tone RU, a pilot mapping matrix for a subcarrier(s) on ID symbol n determined in the second manner includes: a pilot mapping matrix for the subcarrier(s) on the ID symbol n determined according to Equation (5).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R 4 \times {996}_{i}}} = ( - 1 ) \times \{ {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} , {Ψ}_{( n + 15 ) mod 8} , \}$$

$${M}_{n}^{k ∉ {K}_{R 4 \times {996}_{i}}} = 0$$

$$where {M}_{n}^{{K}_{R 4 \times {996}_{i}}}$$

represents a pilot mapping matrix corresponding to a subcarrier set K_{R4λ996}_{ᵢ} determined in the first manner, and

$${M}_{n}^{k ∉ {K}_{R 4 \times {996}_{i}}} = 0$$

represents that for a non-pilot subcarrier(s) in the 4×996-tone RU, a corresponding pilot mapping matrix takes the value of 0.

Manner 2: the pilot mapping matrix for the subcarrier(s) on the ID symbol is determined to be a first pilot mapping matrix in the first manner, a pilot mapping matrix for a subcarrier(s) on a first symbol is also determined to be the first pilot mapping matrix in the second manner, and the ID symbol and the first symbol are adjacent symbols.

That is, the transmitting device can indicate that the UHR PPDU contains the ID field by setting a pilot mapping matrix for a subcarrier(s) on one symbol to be the same as a pilot mapping matrix for a subcarrier(s) on an adjacent symbol.

Correspondingly, when a pilot mapping matrix for a subcarrier(s) on the two adjacent symbols is the same as a pilot mapping matrix for a subcarrier(s) on an adjacent symbol, the receiving device can determine that the UHR PPDU contains the ID field.

In some embodiments, the first symbol is a previous symbol adjacent to the ID symbol, or may be a subsequent symbol adjacent to the ID symbol, which is not limited in the present disclosure.

In some embodiments, for a 242-tone RU, a pilot mapping matrix for a subcarrier(s) on ID symbol n determined in the second manner includes: a pilot mapping matrix for the subcarrier(s) on the ID symbol n determined according to Equation (1).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R {242}_{i}}} = \{ {Ψ}_{( n - 1 ) mod 8} , {Ψ}_{n mod 8} , {Ψ}_{( n + 1 ) mod 8} , {Ψ}_{( n + 2 ) mod 8} {Ψ}_{( n + 3 ) mod 8} , {Ψ}_{( n + 4 ) mod 8} , {Ψ}_{( n + 5 ) mod 8} , {Ψ}_{( n + 6 ) mod 8} , \}$$

$${M}_{n}^{k ∉ {K}_{R {242}_{i}}} = 0$$

$$where {M}_{n}^{{K}_{R {242}_{i}}}$$

represents a pilot mapping matrix corresponding to a subcarrier set K_{R242}_{ᵢ} determined in the first manner, K_{R242}_{ᵢ} represents a pilot subcarrier in the 242-tone RU, and

$${M}_{n}^{k ∉ {K}_{R {242}_{i}}} = 0$$

represents that for a non-pilot subcarrier(s) in the 242-tone RU, a corresponding pilot mapping matrix takes the value of 0.

In some embodiments, for a 484-tone RU, a pilot mapping matrix for a subcarrier(s) on ID symbol n determined in the second manner includes: a pilot mapping matrix for the subcarrier(s) on the ID symbol n determined according to Equation (2).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R {484}_{i}}} = \{ {Ψ}_{( n - 1 ) mod 8} , {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} \}$$

$${M}_{n}^{k ∉ {K}_{R {484}_{i}}} = 0$$

$$where {M}_{n}^{{K}_{R {484}_{i}}}$$

represents a pilot mapping matrix corresponding to a subcarrier set K_{R484}_{ᵢ} determined in the first manner, and

$${M}_{n}^{k ∉ {K}_{R {484}_{i}}} = 0$$

represents that for a non-pilot subcarrier(s) in the 484-tone RU, a corresponding pilot mapping matrix takes the value of 0.

In some embodiments, for a 996-tone RU, a pilot mapping matrix for a subcarrier(s) on ID symbol n determined in the second manner includes: a pilot mapping matrix for the subcarrier(s) on the ID symbol n determined according to Equation (3).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R {996}_{i}}} = \{ {Ψ}_{( n - 1 ) mod 8} , {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} \}$$

$${M}_{n}^{k ∉ {K}_{R {996}_{i}}} = 0$$

$$where {M}_{n}^{{K}_{R {996}_{i}}}$$

represents a pilot mapping matrix corresponding to a subcarrier set K_{R996}_{ᵢ} determined in the first manner, and

$${M}_{n}^{k ∉ {K}_{R {996}_{i}}} = 0$$

represents that for a non-pilot subcarrier(s) in the 996-tone RU, a corresponding pilot mapping matrix takes the value of 0.

In some embodiments, for a 2×996-tone RU, a pilot mapping matrix for a subcarrier(s) on ID symbol n determined in the second manner includes: a pilot mapping matrix for the subcarrier(s) on the ID symbol n determined according to Equation (4).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R 2 \times {996}_{i}}} = \{ {Ψ}_{( n - 1 ) mod 8} , {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} {Ψ}_{( n - 1 ) mod 8} , {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} \}$$

$${M}_{n}^{k ∉ {K}_{R 2 \times {996}_{i}}} = 0$$

$$where {M}_{n}^{{K}_{R 2 \times {996}_{i}}}$$

represents a pilot mapping matrix corresponding to a subcarrier set K_{R2×996}_{ᵢ} determined in the first manner, and

$${M}_{n}^{k ∉ {K}_{R 2 \times {996}_{i}}} = 0$$

represents that for a non-pilot subcarrier(s) in the 2×996-tone RU, a corresponding pilot mapping matrix takes the value of 0.

In some embodiments, for a 4×996-tone RU, a pilot mapping matrix for a subcarrier(s) on ID symbol n determined in the second manner includes: a pilot mapping matrix for the subcarrier(s) on the ID symbol n determined according to Equation (5).

Correspondingly, a pilot mapping matrix for the subcarrier on the ID symbol n determined in the first manner can include: a pilot mapping matrix for the subcarrier on the ID symbol n determined according to the following equation:

$${M}_{n}^{{K}_{R 4 \times {996}_{i}}} = \{ {Ψ}_{( n - 1 ) mod 8} , {Ψ}_{n mod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} {Ψ}_{( n - 1 ) mod 8} , {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} {Ψ}_{( n - 1 ) mod 8} , {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} {Ψ}_{( n - 1 ) mod 8} , {Ψ}_{nmod 8} , {Ψ}_{( n + 1 ) mod 8} , {Ψ}_{( n + 2 ) mod 8} , {Ψ}_{( n + 3 ) mod 8} , {Ψ}_{( n + 4 ) mod 8} , {Ψ}_{( n + 5 ) mod 8} , {Ψ}_{( n + 6 ) mod 8} , {Ψ}_{( n + 7 ) mod 8} , {Ψ}_{( n + 8 ) mod 8} , {Ψ}_{( n + 9 ) mod 8} , {Ψ}_{( n + 10 ) mod 8} , {Ψ}_{( n + 11 ) mod 8} , {Ψ}_{( n + 12 ) mod 8} , {Ψ}_{( n + 13 ) mod 8} , {Ψ}_{( n + 14 ) mod 8} \}$$

$${M}_{n}^{k ∉ {K}_{R 4 \times {996}_{i}}} = 0$$

$$where {M}_{n}^{{K}_{R 4 \times {996}_{i}}}$$

represents a pilot mapping matrix corresponding to a subcarrier set K_{R4×996}_{ᵢ} determined in the first manner, and

$${M}_{n}^{k ∉ {K}_{R 4 \times {996}_{i}}} = 0$$

represents that for a non-pilot subcarrier(s) in the 4×996-tone RU, a corresponding pilot mapping matrix takes the value of 0.

In the example, the pilot mapping matrix for the subcarrier on the ID symbol n is the same as a pilot mapping matrix for a subcarrier(s) on a previous symbol (i.e., symbol n−1) determined in the second manner, or the pilot mapping matrix for the subcarrier on the ID symbol n may be the same as a pilot mapping matrix for a subcarrier(s) on a subsequent symbol (i.e., symbol n+1) determined in the second manner, with the similar implementation manner, which will not be repeated herein.

In some embodiments, a value of Ψₘ (where m=0, 1, . . . , 7) may be predefined. For example, Ψₘ is as defined in Table 5.

In some embodiments of the present disclosure, the method 200 further includes the following. A PHY of the receiving device transmits a first primitive to a station management entity (SME) or an MAC sublayer management entity (MLME) of the receiving device, where the first primitive indicates a detection result of the transmitting device obtained from the one or more UHR PPDUs.

In some embodiments, the detection result of the transmitting device includes at least one of: the number of transmitting devices detected from the ID field, an ID list of the transmitting devices detected from the ID field, state information of the transmitting devices detected from the ID field, or the usage of the ID field.

In some embodiments, information of the number of transmitting devices may be determined according to the number of UHR PPDUs or ID fields. For example, in the case where all ID subfields in an ID field in one UHR PPDU are transmitted by the same transmitting device, the number of transmitting devices can be determined according to the number of UHR PPDUs or ID fields. Alternatively, information of the number of transmitting devices may be determined according to the number of ID subfields. For example, in the case where different ID subfields in an ID field in a UHR PPDU are transmitted by different transmitting devices, the number of transmitting devices can be determined according to the number of ID subfields in the UHR PPDU.

In some embodiments, the ID list of the transmitting devices can be determined according to a subcarrier set for an ID field or an ID subfield in a UHR PPDU.

In some embodiments, the state information of the transmitting device can be determined according to a subcarrier set for an ID field or an ID subfield in a UHR PPDU. For example, in Embodiment 3-1, one transmitting device corresponds to two subcarrier sets, and different subcarrier sets can indicate different state information of the transmitting device. Therefore, the state information of the transmitting device can be determined according to the subcarrier set for the ID field or the ID subfield in the UHR PPDU.

In some embodiments, the usage of the ID field can be obtained from the usage field in the foregoing embodiments.

In some embodiments, the PHY of the receiving device can define at least one of the following TXVECTOR parameters and RXVECTOR parameters: UIE_NUM_USER (RXVECTOR parameter), UIE_USER_INDEX (RXVECTOR parameter), UIE_STATUS (RXVECTOR parameter), UIE_PRESENT (TXVECTOR parameter), NUM_UIE_SUBFIELD (TXVECTOR parameter), UIE_TONE_SET_INDEX (TXVECTOR parameter), UIE_TYPE (RXVECTOR parameter and TXVECTOR parameter), or NUMBER_OF_SPATIALLY_MULTIPLEXED_USERS (TXVECTOR parameter). The UIE_NUM_USER indicates the number of users (i.e., the number of transmitting devices) detected from an ID field. The UIE_USER_INDEX indicates an ID list of users (i.e., the transmitting devices) detected from an ID field, e.g., an AID, a UID, an MAC address, etc. The UIE_STATUS indicates a status list of users detected from an ID field. The UIE_PRESENT indicates whether a UIE field is present in a PPDU. The NUM_UIE_SUBFIELD indicates the number of UIE subfields contained in a UIE field. The UIE_TONE_SET_INDEX indicates a subcarrier set (i.e., tone set) for a UIE field. The UIE_TYPE indicates the usage or type of a UIE field. The NUMBER_OF_SPATIALLY_MULTIPLEXED_USERS indicates the number of users that are multiplexed on a same subcarrier set.

In some embodiments, the TXVECTOR parameters and the RXVECTOR parameters can be present in the case where the UHR PPDU is a UHR MU PPDU, a UHR TB PPDU, or a UHR ER PPDU.

In some embodiments, the first primitive is also referred to as “PHY-UIEREPORT.indication”, “detection result indication”, etc., and the name of the first primitive is not specifically limited in the present disclosure.

In some embodiments, the first primitive (PHY-UIEREPORT.indication) can include the following primitive parameters:

```
PHY-UIEREPORT.indication(
  UIE_NUM_USER,
  UIE_USER_INDEX,
  UIE_STATUS,
  UIE_TYPE
  )
```

where UIE_NUM_USER represents the number of users detected from a UIE field.

UIE_USER_INDEX represents a list of ID information of users detected by a receiving device, with a length equal to a value of UIE_NUM_USER. The ID information may be an AID, a UID, an MAC address, or a symbol used for identifying an identity of a user. When the value of the UIE_NUM_USER is 0, this parameter is not present.

UIE_STATUS indicates a list of status of detected users, where the i-th status in the list corresponds to ID information of the i-th user in USER_INDEX.

UIE_TYPE indicates the usage of a UIE field.

In some embodiments, the first primitive is generated when the PHY of the receiving device successfully receives the ID field and completes detection of the transmitting device from the ID field, and the first primitive is used for reporting the detection result of the transmitting device to the MLME or the SME of the receiving device.

In some embodiments, the SME or the MLME of the receiving device obtains the detection result of the transmitting device from the first primitive.

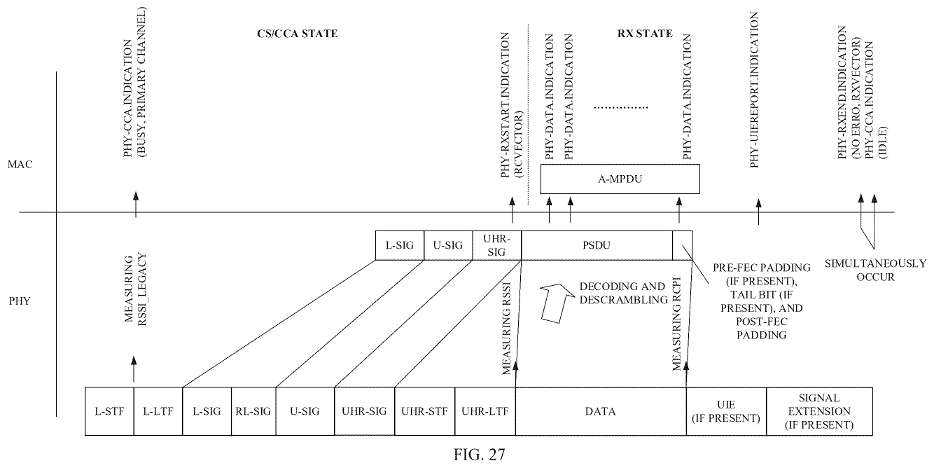

The following illustrates a reception flow of the first primitive in conjunction with FIG. 27 to FIG. 34.

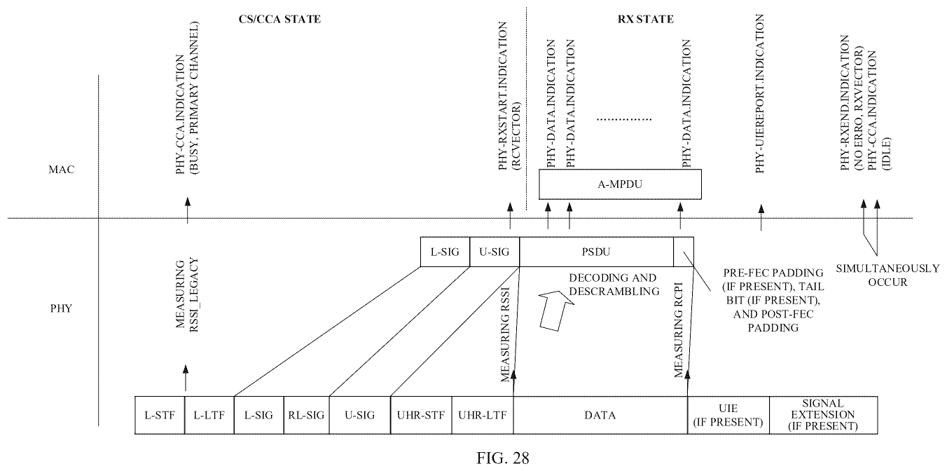

The reception flow illustrated in FIG. 27 and FIG. 28 is applicable to the format design of the UHR PPDU in Embodiment 1-1, i.e., the UHR PPDU can contain a UIE field but not contain a PE field.

FIG. 27 illustrates a schematic diagram of a reception flow of a first primitive according to embodiments of the present disclosure. In the example of FIG. 27, a UHR PPDU may be a UHR MU PPDU and a UHR ER PPDU, and a specific implementation flow is as follows.

When a PHY of a receiving device receives an L-STF field in the UHR MU PPDU and the UHR ER PPDU, the PHY of the receiving device is required to measure a legacy received signal strength indication (RSSI) (RSSI_LEGACY) and to inform, through PHY-CCA.indication, an MAC that a primary channel is busy. In this case, the receiving device enters a carrier sensing (CS) state or a clear channel assessment (CCA) state.

Then, the PHY receives a subsequent midamble field and a subsequent signaling field, and reports an L-SIG, a U-SIG, a UHR-SIG, and an RSSI, in a form of RXVECTOR through PHY-RXSTART.indication, to the MAC of the receiving device. Then, the PHY of the receiving device receives a data field, restores a physical layer protocol service unit (PPSU) by decoding and descrambling the data field, and reports the PPSU to the MAC of the receiving device through PHY-DATA.indication. In this case, the receiving device enters a receiving (Rx) state. If a UIE field is present, after the PHY of the receiving device receives the UIE field, the PHY is required to report a result of MU detection to the MAC of the receiving device through PHY-UIEREPORT.indication. If a signal extension field is present, after the PHY of the receiving device receives the signal extension field, the PHY is required to inform, in the form of RXVECTOR through PHY-RXEND.indication, the MAC of the receiving device that there is no error in reception, and to inform, through PHY-CCA.indication, the MAC of the receiving device that the channel is idle at this time.

FIG. 28 illustrates a schematic diagram of a reception flow of another first primitive according to embodiments of the present disclosure. In the example of FIG. 28, a UHR PPDU may be a UHR TB PPDU, and the UHR PPDU can adopt the format design in Embodiment 1-1, i.e., the UHR PPDU can contain a UIE field but not contain a PE field. A specific implementation flow is as follows.

When a PHY of a receiving device receives an L-STF field in the UHR TB PPDU, the PHY of the receiving device is required to measure a RSSI_LEGACY and to inform, through PHY-CCA.indication, an MAC that a primary channel is busy. In this case, the receiving device enters a CS state or a CCA state.

Then, the PHY receives a subsequent midamble field and a subsequent signaling field, and reports an L-SIG, a U-SIG, a UHR-SIG, and an RSSI, in the form of RXVECTOR through PHY-RXSTART.indication, to the MAC of the receiving device. Then, the PHY of the receiving device receives a data field, restores a PPSU by decoding and descrambling the data field, and reports the PPSU to the MAC of the receiving device through PHY-DATA.indication. In this case, the receiving device enters an Rx state. If a UIE field is present, after the PHY of the receiving device receives the UIE field, the PHY is required to report a result of MU detection to the MAC of the receiving device through PHY-UIEREPORT.indication. If a signal extension field is present, after the PHY of the receiving device receives the signal extension field, the PHY is required to inform, in the form of RXVECTOR through PHY-RXEND.indication, the MAC of the receiving device that there is no error in reception, and to inform, through PHY-CCA.indication, the MAC of the receiving device that the channel is idle at this time.

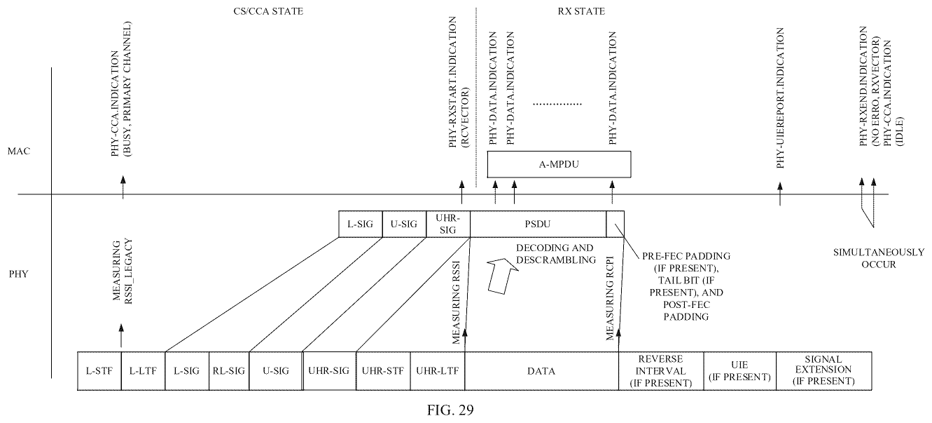

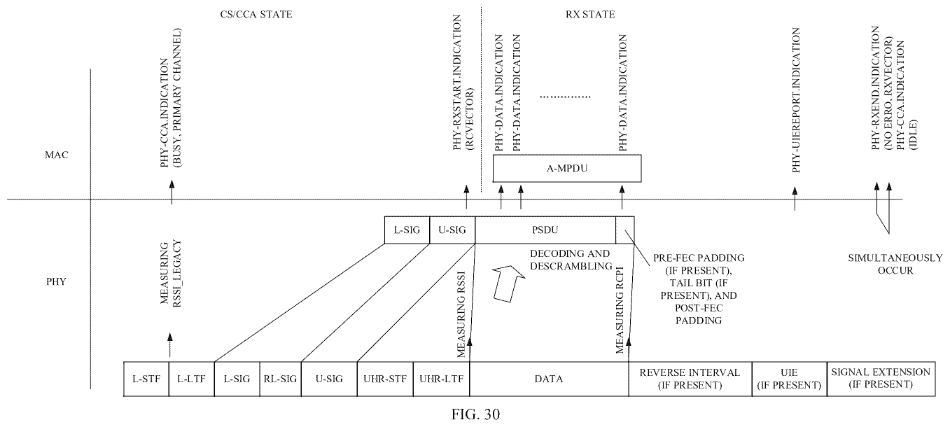

The reception flow illustrated in FIG. 29 and FIG. 30 is applicable to the format design of the UHR PPDU in Embodiment 1-2, i.e., the UHR PPDU can contain a reverse interval field and a UIE field but not contain a PE field.

FIG. 29 illustrates a schematic diagram of a reception flow of yet another first primitive according to embodiments of the present disclosure. In the example of FIG. 29, a UHR PPDU may be a UHR MU PPDU and a UHR ER PPDU, and a specific implementation flow is as follows.

When a PHY of a receiving device receives an L-STF field in the UHR MU PPDU and the UHR ER PPDU, the PHY of the receiving device is required to measure a RSSI_LEGACY and to inform, through PHY-CCA.indication, an MAC that a primary channel is busy. In this case, the receiving device enters a CS state or a CCA state.

Then, the PHY receives a subsequent midamble field and a subsequent signaling field, and reports an L-SIG, a U-SIG, a UHR-SIG, and an RSSI, in a form of RXVECTOR through PHY-RXSTART.indication, to the MAC of the receiving device. Then, the PHY of the receiving device receives a data field, restores a PPSU by decoding and descrambling the data field, and reports the PPSU to the MAC of the receiving device through PHY-DATA.indication. In this case, the receiving device enters an Rx state.

If a reverse interval field is present, the receiving device is required to receive the reverse interval field. If a UIE field is present, after the PHY of the receiving device receives the UIE field, the PHY is required to report a result of MU detection to the MAC of the receiving device through PHY-UIEREPORT.indication. If a signal extension field is present, after the PHY of the receiving device receives the signal extension field, the PHY is required to inform, in the form of RXVECTOR through PHY-RXEND.indication, the MAC of the receiving device that there is no error in reception, and to inform, through PHY-CCA.indication, the MAC of the receiving device that the channel is idle at this time.

FIG. 30 illustrates a schematic diagram of a reception flow of yet another first primitive according to embodiments of the present disclosure. In the example of FIG. 30, a UHR PPDU may be a UHR TB PPDU. A specific implementation flow is as follows.

When a PHY of a receiving device receives an L-STF field in the UHR TB PPDU, the PHY of the receiving device is required to measure a RSSI_LEGACY and to inform, through PHY-CCA.indication, an MAC that a primary channel is busy. In this case, the receiving device enters a CS state or a CCA state.

Then, the PHY receives a subsequent midamble field and a subsequent signaling field, and reports an L-SIG, a U-SIG, a UHR-SIG, and an RSSI, in the form of RXVECTOR through PHY-RXSTART.indication, to the MAC of the receiving device. Then, the PHY of the receiving device receives a data field, restores a PPSU by decoding and descrambling the data field, and reports the PPSU to the MAC of the receiving device through PHY-DATA.indication. In this case, the receiving device enters an Rx state.

If a reverse interval field is present, the receiving device is required to receive the reverse interval field. If a UIE field is present, after the PHY of the receiving device receives the UIE field, the PHY is required to report a result of MU detection to the MAC of the receiving device through PHY-UIEREPORT.indication. If a signal extension field is present, after the PHY of the receiving device receives the signal extension field, the PHY is required to inform, in the form of RXVECTOR through PHY-RXEND.indication, the MAC of the receiving device that there is no error in reception, and to inform, through PHY-CCA.indication, the MAC of the receiving device that the channel is idle at this time.

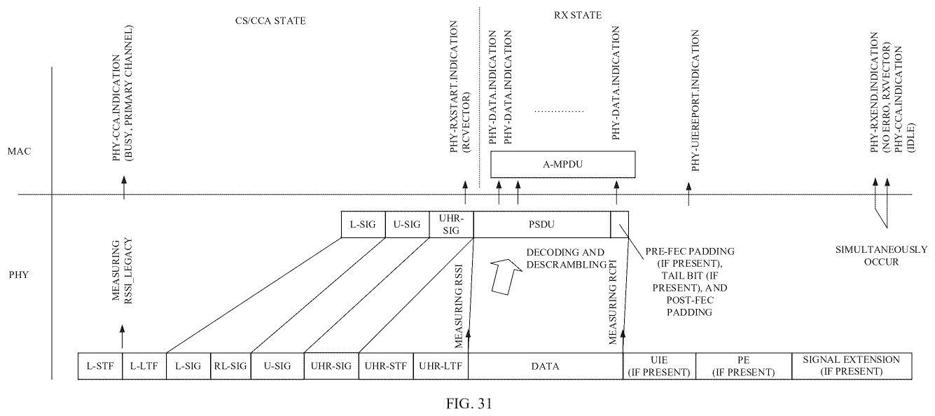

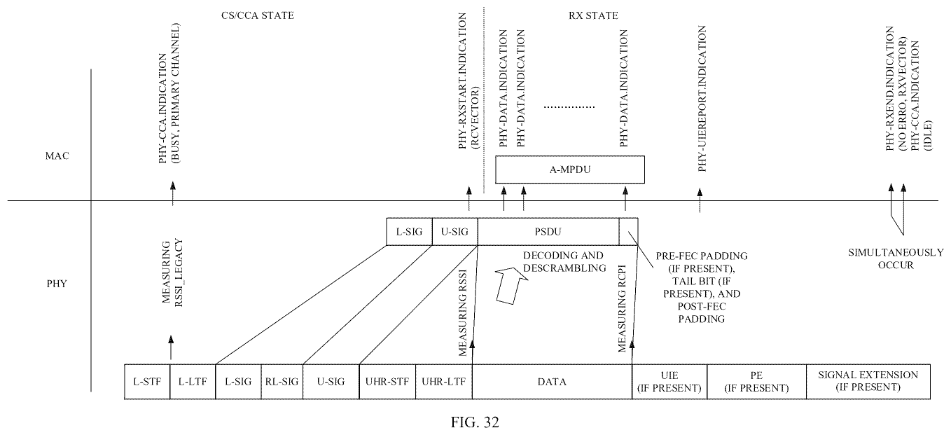

The reception flow illustrated in FIG. 31 and FIG. 32 is applicable to the format design of the UHR PPDU in Embodiment 1-3, i.e., the UHR PPDU can contain a UIE field and a PE field.

FIG. 31 illustrates a schematic diagram of a reception flow of a first primitive according to embodiments of the present disclosure. In the example of FIG. 31, a UHR PPDU may be a UHR MU PPDU and a UHR ER PPDU, and a specific implementation flow is as follows.

When a PHY of a receiving device receives an L-STF field in the UHR MU PPDU and the UHR ER PPDU, the PHY of the receiving device is required to measure a RSSI_LEGACY and to inform, through PHY-CCA.indication, an MAC that a primary channel is busy. In this case, the receiving device enters a CS state or a CCA state.

Then, the PHY receives a subsequent midamble field and a subsequent signaling field, and reports an L-SIG, a U-SIG, a UHR-SIG, and an RSSI, in a form of RXVECTOR through PHY-RXSTART.indication, to the MAC of the receiving device. Then, the PHY of the receiving device receives a data field, restores a PPSU by decoding and descrambling the data field, and reports the PPSU to the MAC of the receiving device through PHY-DATA.indication. In this case, the receiving device enters an Rx state. If a UIE field is present, after the PHY of the receiving device receives the UIE field, the PHY is required to report a result of MU detection to the MAC of the receiving device through PHY-UIEREPORT.indication. If a PE field is present, the PHY of the receiving device is required to receive the PE field. If a signal extension field is present, after the PHY of the receiving device receives the signal extension field, the PHY is required to inform, in the form of RXVECTOR through PHY-RXEND.indication, the MAC of the receiving device that there is no error in reception, and to inform, through PHY-CCA.indication, the MAC of the receiving device that the channel is idle at this time.

FIG. 32 illustrates a schematic diagram of a reception flow of another first primitive according to embodiments of the present disclosure. In the example of FIG. 32, a UHR PPDU may be a UHR TB PPDU. A specific implementation flow is as follows.

When a PHY of a receiving device receives an L-STF field in the UHR TB PPDU, the PHY of the receiving device is required to measure a RSSI_LEGACY and to inform, through PHY-CCA.indication, an MAC that a primary channel is busy. In this case, the receiving device enters a CS state or a CCA state.

Then, the PHY receives a subsequent midamble field and a subsequent signaling field, and reports an L-SIG, a U-SIG, a UHR-SIG, and an RSSI, in the form of RXVECTOR through PHY-RXSTART.indication, to the MAC of the receiving device. Then, the PHY of the receiving device receives a data field, restores a PPSU by decoding and descrambling the data field, and reports the PPSU to the MAC of the receiving device through PHY-DATA.indication. In this case, the receiving device enters an Rx state. If a UIE field is present, after the PHY of the receiving device receives the UIE field, the PHY is required to report a result of MU detection to the MAC of the receiving device through PHY-UIEREPORT.indication. If a signal extension field is present, after the PHY of the receiving device receives the signal extension field, the PHY is required to inform, in the form of RXVECTOR through PHY-RXEND.indication, the MAC of the receiving device that there is no error in reception, and to inform, through PHY-CCA.indication, the MAC of the receiving device that the channel is idle at this time.

The reception flow illustrated in FIG. 29 and FIG. 30 is applicable to the format design of the UHR PPDU in Embodiment 1-4, i.e., the UHR PPDU can contain a reverse interval field, a UIE field, and a PE field.

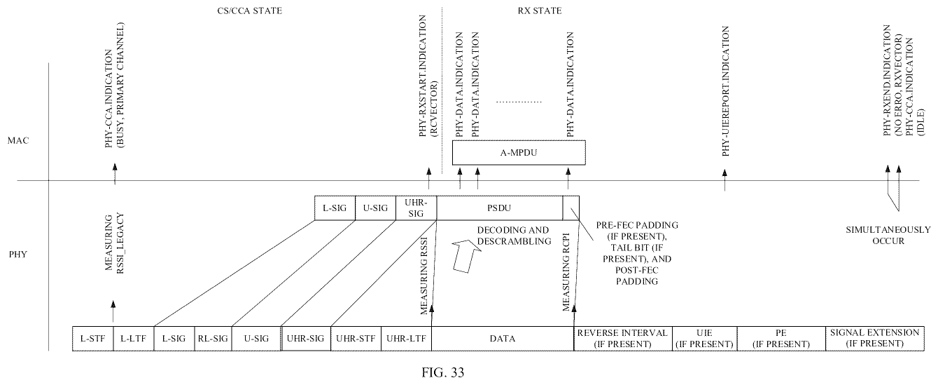

FIG. 33 illustrates a schematic diagram of a reception flow of yet another first primitive according to embodiments of the present disclosure. In the example of FIG. 33, a UHR PPDU may be a UHR MU PPDU and a UHR ER PPDU, and a specific implementation flow is as follows.

When a PHY of a receiving device receives an L-STF field in the UHR MU PPDU and the UHR ER PPDU, the PHY of the receiving device is required to measure a RSSI_LEGACY and to inform, through PHY-CCA.indication, an MAC that a primary channel is busy. In this case, the receiving device enters a CS state or a CCA state.

Then, the PHY receives a subsequent midamble field and a subsequent signaling field, and reports an L-SIG, a U-SIG, a UHR-SIG, and an RSSI, in a form of RXVECTOR through PHY-RXSTART.indication, to the MAC of the receiving device. Then, the PHY of the receiving device receives a data field, restores a PPSU by decoding and descrambling the data field, and reports the PPSU to the MAC of the receiving device through PHY-DATA.indication. In this case, the receiving device enters an Rx state.

If a reverse interval field is present, the receiving device is required to receive the reverse interval field. If a UIE field is present, after the PHY of the receiving device receives the UIE field, the PHY is required to report a result of MU detection to the MAC of the receiving device through PHY-UIEREPORT.indication. If a PE field is present, the receiving device is required to receive the PE field. If a signal extension field is present, after the PHY of the receiving device receives the signal extension field, the PHY is required to inform, in the form of RXVECTOR through PHY-RXEND.indication, the MAC of the receiving device that there is no error in reception, and to inform, through PHY-CCA.indication, the MAC of the receiving device that the channel is idle at this time.

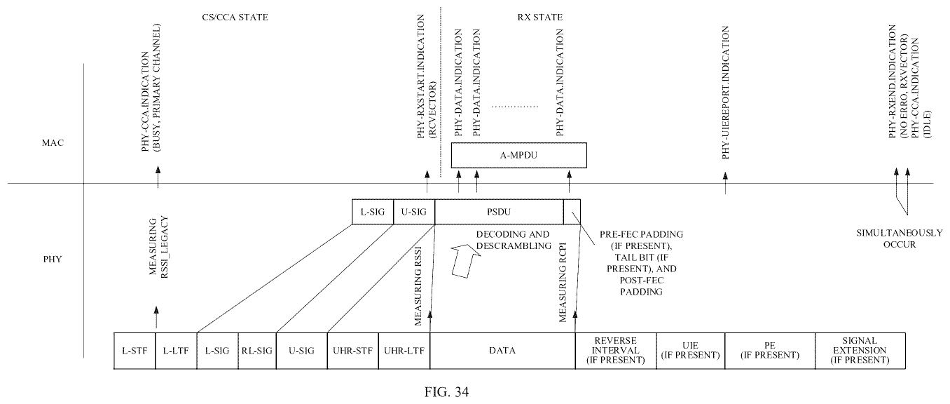

FIG. 34 illustrates a schematic diagram of a reception flow of yet another first primitive according to embodiments of the present disclosure. In the example of FIG. 34, a UHR PPDU may be a UHR TB PPDU. A specific implementation flow is as follows.

When a PHY of a receiving device receives an L-STF field in the UHR TB PPDU, the PHY of the receiving device is required to measure a RSSI_LEGACY and to inform, through PHY-CCA.indication, an MAC that a primary channel is busy. In this case, the receiving device enters a CS state or a CCA state.

Then, the PHY receives a subsequent midamble field and a subsequent signaling field, and reports an L-SIG, a U-SIG, a UHR-SIG, and an RSSI, in the form of RXVECTOR through PHY-RXSTART.indication, to the MAC of the receiving device. Then, the PHY of the receiving device receives a data field, restores a PPSU by decoding and descrambling the data field, and reports the PPSU to the MAC of the receiving device through PHY-DATA.indication. In this case, the receiving device enters an Rx state.

If a reverse interval field is present, the receiving device is required to receive the reverse interval field. If a UIE field is present, after the PHY of the receiving device receives the UIE field, the PHY is required to report a result of MU detection to the MAC of the receiving device through PHY-UIEREPORT.indication. If a PE field is present, the receiving device is required to receive the PE field. If a signal extension field is present, after the PHY of the receiving device receives the signal extension field, the PHY is required to inform, in the form of RXVECTOR through PHY-RXEND.indication, the MAC of the receiving device that there is no error in reception, and to inform, through PHY-CCA.indication, the MAC of the receiving device that the channel is idle at this time.

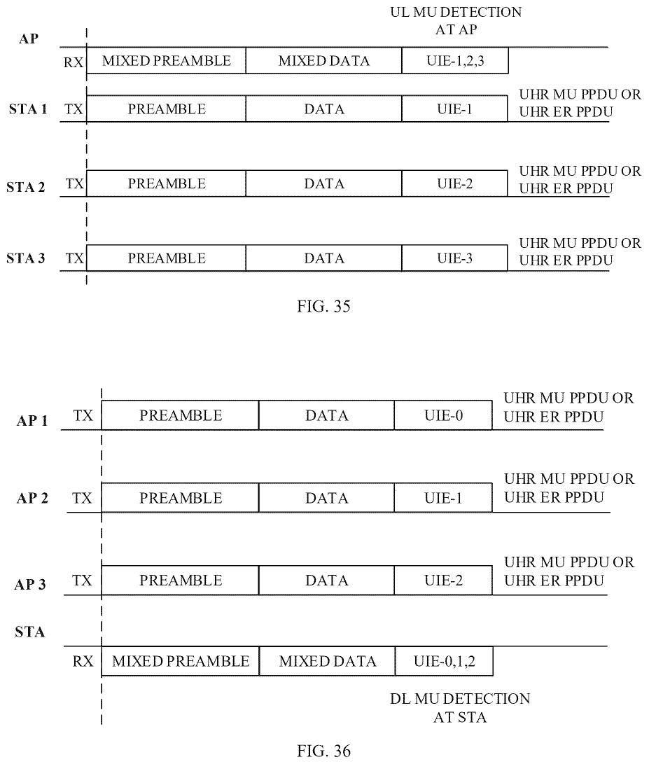

In conjunction with FIG. 35 to FIG. 40, a method for MU detection of a UHR PPDU according to embodiments of the present disclosure is illustrated below.

FIG. 35 illustrates a method for UL MU detection of a UHR PPDU according to embodiments of the present disclosure. In this example, an AP can be a receiving device, a transmitting device can include three non-AP STAs (STA1, STA2, and STA3), and a format of the UHR PPDU can adopt the format design in Embodiment 1-1 and Embodiment 1-3. A specific detection process is as follows.

STA1, STA2, and STA3 each can actively transmit a UHR MU PPDU or a UHR ER PPDU containing an ID field, where a UIE field in a UL UHR MU PPDU or a UL UHR ER PPDU transmitted by STA1 indicates ID information of STA1, a UIE field in a UL UHR MU PPDU or a UL UHR ER PPDU transmitted by STA2 indicates ID information of STA2, and a UIE field in a UL UHR MU PPDU or a UL UHR ER PPDU transmitted by STA3 indicates ID information of STA3.

Correspondingly, the AP can receive three UHR MU PPDUs or UHR ER PPDUs that are intermixed together. The AP can detect a subcarrier for the UIE field in each of the UHR MU PPDUs or UHR ER PPDUs (e.g., by detecting which subcarriers have energy and/or values on the subcarriers having energy), such that the AP can detect that the intermixed UIE fields include UIE fields transmitted by STA1, STA2, and STA3, respectively, thereby implementing UL MU detection at the AP side.

FIG. 36 illustrates a method for DL MU detection of a UHR PPDU according to embodiments of the present disclosure. In this example, an STA can be a receiving device, a transmitting device can include three APs (AP1, AP2, and AP3), and a format of the UHR PPDU can adopt the format design in Embodiment 1-1 and Embodiment 1-3. A specific detection process is as follows.

AP1, AP2, and AP3 each can actively transmit a UHR MU PPDU or a UHR ER PPDU containing an ID field, where a UIE field in a UHR MU PPDU or a UHR ER PPDU transmitted by AP1 indicates ID information of AP1, a UIE field in a UHR MU PPDU or a UHR ER PPDU transmitted by AP2 indicates ID information of AP2, and a UIE field in a UHR MU PPDU or a UHR ER PPDU transmitted by AP3 indicates ID information of AP3.

Correspondingly, the STA can receive three UHR MU PPDUs or UHR ER PPDUs that are intermixed together. The STA can detect a subcarrier for the UIE field in each of the UHR MU PPDUs or UHR ER PPDUs (e.g., by detecting which subcarriers have energy and/or values on the subcarriers having energy), such that the STA can detect that the intermixed UIE fields include UIE fields transmitted by AP1, AP2, and AP3, respectively, thereby implementing DL MU detection at the STA side.

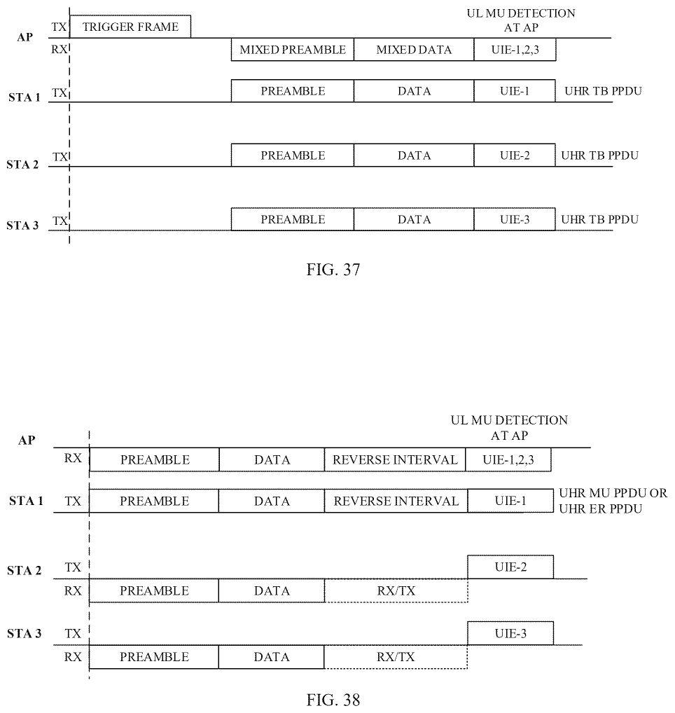

FIG. 37 illustrates another method for UL MU detection of a UHR PPDU according to embodiments of the present disclosure. In this example, an AP can be a receiving device, a transmitting device can include three non-AP STAs (STA1, STA2, and STA3), and a format of the UHR PPDU can adopt the format design in Embodiment 1-1 and Embodiment 1-3. A specific detection process is as follows.

The AP first transmits a trigger frame that contains a random access resource unit (RA-RU), i.e., the trigger frame contains a RU resource(s) to be competed for. In some cases, STA1, STA2, and STA3 can simultaneously transmit a UHR TB PPDU that contains a UIE field, where a UIE field in a UHR TB PPDU transmitted by STA1 indicates ID information of STA1, a UIE field in a UHR TB PPDU transmitted by STA2 indicates ID information of STA2, and a UIE field in a UHR TB PPDU transmitted by STA3 indicates ID information of STA3.

Correspondingly, the AP can receive UHR TB PPDUs that are intermixed together. The AP can detect a subcarrier for the UIE field in each of the UHR TB PPDUs (e.g., by detecting which subcarriers have energy and/or values on the subcarriers having energy), such that the AP can detect that the intermixed UIE fields include UIE fields transmitted by STA1, STA2, and STA3, respectively, thereby implementing UL MU detection at the AP side.

FIG. 37 illustrates another method for UL MU detection of a UHR PPDU according to embodiments of the present disclosure. In this example, an AP can be a receiving device, a transmitting device can include three non-AP STAs (STA1, STA2, and STA3), and a format of the UHR PPDU can adopt the format design in Embodiment 1-2 and Embodiment 1-4. A specific detection process is as follows.

STA1 may transmit a UHR MU PPDU or a UHR ER PPDU containing a UIE field (denoted as UIE-1 field), and the UIE-1 field is used for identifying ID information of STA1.

STA2 and STA3, upon receiving the PPDU, determine whether the PPDU contains a UIE field. For example, STA2 and STA3 can confirm, in the manner in Embodiment 4, that the PPDU contains the UIE field, thereby providing MU detection.

Further, STA2 and STA3 perform state transition (e.g., switching from a receiving state to a transmitting state) during a reverse interval, and then simultaneously transmit a UIE field aligned with the UIE-1 field, respectively, i.e., a UIE-2 field indicating ID information of STA2 and a UIE-3 field indicating ID information of STA3.

Correspondingly, the AP side can receive a preamble and a data part in the PPDU from STA1 as well as the UIE-1 field, the UIE-2 field, and the UIE-3 field that are intermixed together. The AP can detect a subcarrier for each UIE field, such that the AP can detect that the intermixed UIE fields include UIE fields transmitted by STA1, STA2, and STA3, respectively, thereby implementing UL MU detection at the AP side.

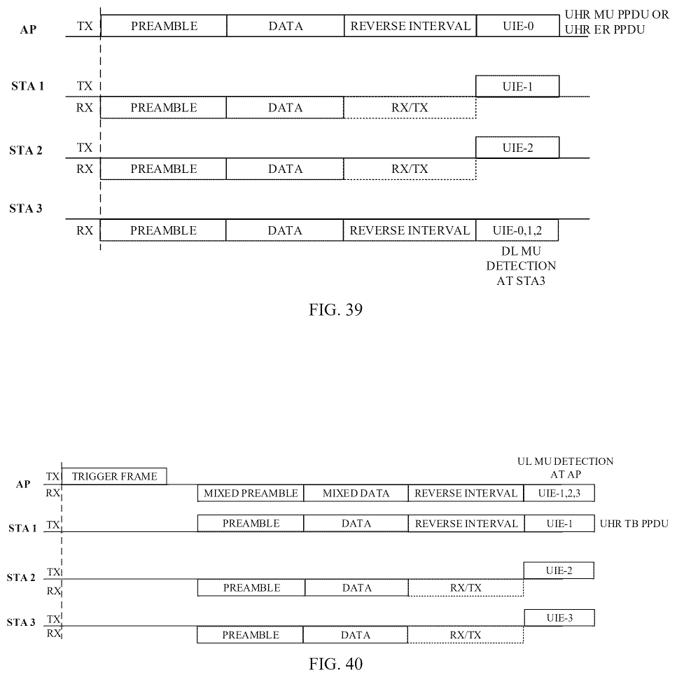

FIG. 39 illustrates another method for MU detection of a UHR PPDU according to embodiments of the present disclosure. In this example, STA3 can be a receiving device, a transmitting device can include an AP, STA1, and STA2, and a format of the UHR PPDU can adopt the format design in Embodiment 1-2 and Embodiment 1-4. A specific detection process is as follows.

The AP may transmit a UHR MU PPDU or a UHR ER PPDU containing a UIE field (i.e., a UIE-0 field), and the UIE-0 field is used for identifying ID information of the AP.

STA1 and STA2, upon receiving the PPDU, determine whether the PPDU contains a UIE field. For example, STA1 and STA2 can confirm, in the manner in Embodiment 4, that the PPDU contains the UIE field, thereby providing MU detection.

Further, STA1 and STA2 perform state transition (e.g., switching from a receiving state to a transmitting state) during a reverse interval, and then simultaneously transmit a UIE field aligned with the UIE-0 field, respectively, i.e., a UIE-1 field indicating ID information of STA1 and a UIE-2 field indicating ID information for STA2.

Correspondingly, the STA3 side can receive a preamble and a data part in the PPDU transmitted by the AP as well as the UIE-0 field, the UIE-1 field, and the UIE-2 field that are intermixed together. STA3 can detect a subcarrier for each of the UIE fields, such that STA3 can detect that the intermixed UIE fields include UIE fields transmitted by the AP, STA1, and STA2, respectively, thereby implementing UL MU detection at the STA3 side.

FIG. 40 illustrates yet another method for MU detection of a UHR PPDU according to embodiments of the present disclosure. In this example, an AP can be a receiving device, a transmitting device can include three non-AP STAs (STA1, STA2, and STA3), and a format of the UHR PPDU can adopt the format design in Embodiment 1-2 and Embodiment 1-4. A specific detection process is as follows.

The AP first triggers, through a trigger frame, STA1 to transmit a UHR TB PPDU, the transmitted UHR TB PPDU contains a UIE field (denoted as UIE-1 field), and the UIE-1 field is used for identifying ID information of STA1.

STA2 and STA3, upon receiving the PPDU, determine whether the PPDU contains a UIE field. For example, STA2 and STA3 can confirm, in the manner in Embodiment 4, that the PPDU contains the UIE field, thereby providing MU detection.

Further, STA2 and STA3 perform state transition (e.g., switching from a receiving state to a transmitting state) during a reverse interval, and then simultaneously transmit a UIE field aligned with the UIE-1 field, respectively, i.e., a UIE-2 field indicating ID information of STA2 and a UIE-3 field indicating ID information of STA3.

Correspondingly, the AP side can receive a preamble and a data part in the PPDU from STA1 as well as the UIE-1 field, the UIE-2 field, and the UIE-3 field that are intermixed together. The AP can detect a subcarrier for each UIE field, such that the AP can detect that the intermixed UIE fields include UIE fields transmitted by STA1, STA2, and STA3, respectively, thereby implementing UL MU detection at the AP side.

In summary, in embodiments of the present disclosure, the receiving device can identify the identity of the transmitting device according to the ID field in the UHR PPDU transmitted by the transmitting device, such that MU detection can be implemented. The UHR PPDU provided in embodiments of the present disclosure is not required to be used in combination with an NFRP trigger frame, and in the case where the AP does not obtain a TXOP, MU detection can be implemented through an ID field in a certain UL or DL UHR PPDU, such that application timing and scenarios of MU detection can be expanded, thereby allowing the function of MU detection to be implemented in different scenarios.

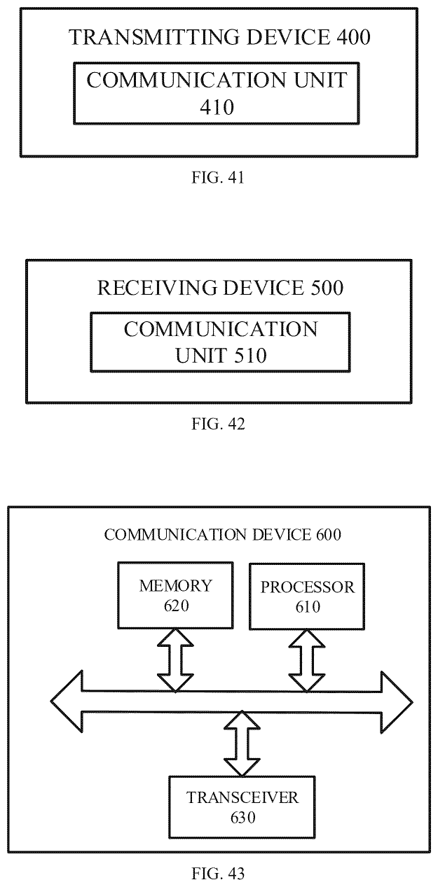

The method embodiment of the present disclosure is described in detail above in conjunction with FIG. 9 to FIG. 40, and the apparatus embodiment of the present disclosure is described in detail below in conjunction with FIG. 41 to FIG. 45. It can be understood that, the apparatus embodiment and the method embodiment correspond to each other, and for similar descriptions, reference may be made to that in the method embodiment.

FIG. 41 illustrates a schematic block diagram of a transmitting device 400 according to embodiments of the present disclosure. As illustrated in FIG. 41, the transmitting device 400 includes a communication unit 410. The communication unit 410 is configured to transmit a UHR PPDU, where the UHR PPDU contains an ID field, and the ID field indicates ID information of the transmitting device.

In some embodiments, a subcarrier used for the ID field indicates the ID information of the transmitting device.

In some embodiments, the UHR PPDU is a UHR MU PPDU, a UHR TB PPDU, or a UHR ER PPDU.

In some embodiments, the UHR PPDU does not contain a PE field, and the ID field is carried at the tail of the UHR PPDU.

In some embodiments, the UHR PPDU contains a PE field, and the ID field is positioned before the PE field.

In some embodiments, the UHR PPDU further contains a reverse interval field, and the reverse interval field is used for reserving an interval for a receiving device of the UHR PPDU to reverse from a receiving state to a transmitting state.

In some embodiments, the reverse interval field is positioned before the ID field.

In some embodiments, the ID field contains one or more ID subfields, and the one or more ID subfields indicate the ID information of the transmitting device.

In some embodiments, the ID field further contains a UHR-STF.

In some embodiments, the ID field further contains one or more UHR-LTFs.

In some embodiments, the ID field further contains a legacy preamble field.

In some embodiments, the legacy preamble field contains the following fields: an L-STF, an L-LTF, an L-SIG, an RL-SIG, and a U-SIG.

In some embodiments, the legacy preamble field contains the following fields: an L-STF, an L-LTF, an L-SIG, an RL-SIG, a U-SIG, and a UHR-SIG.

In some embodiments, a subcarrier used for the one or more ID subfields indicates the ID information of the transmitting device.

In some embodiments, the ID information of the transmitting device corresponds to two subcarrier sets, and a subcarrier used for the ID subfield belongs to one of the two subcarrier sets.

In some embodiments, the subcarrier used for the ID subfield belonging to different subcarrier sets of the two subcarrier sets indicates different state information of the transmitting device, respectively.

In some embodiments, a bandwidth for the ID subfield is 20 MHz, 40 MHz, 80 MHz, 80+80 MHz, 160 MHz, or 320 MHz.

In some embodiments, the 320 MHz is represented by subcarrier set indices of four 80 MHz, where subcarrier set indices 1-72 are mapped to a first 80 MHz, subcarrier set indices 73-144 are mapped to a second 80 MHz, subcarrier set indices 145-216 are mapped to a third 80 MHz, and subcarrier set indices 217-288 are mapped to a fourth 80 MHz.

In some embodiments, the ID information of the transmitting device corresponds to one subcarrier set, and a subcarrier used for the ID subfield belongs to the subcarrier set.

In some embodiments, a correspondence between the ID information of the transmitting device and the subcarrier set is predefined.

In some embodiments, the UHR PPDU further contains a control field, and the control field indicates whether the UHR PPDU contains the ID field and/or configuration information of the ID field.

In some embodiments, the configuration information of the ID field includes at least one of: the number of ID subfields contained in the ID field, usage of the ID field, or the number of devices that are multiplexed on one set of subcarriers in a same RU.

In some embodiments, the control field contains at least one of the following fields: an ID present field indicating whether the ID field is present in the UHR PPDU; a first number field indicating the number of ID subfields contained in the ID field; a usage field indicating usage of the ID field; or a second number field indicating the number of devices that are multiplexed on one set of subcarriers in a same RU.

In some embodiments, the UHR PPDU contains a U-SIG field, and the control field is carried in the U-SIG field.

In some embodiments, the UHR PPDU contains a UHR-SIG field, and the control field is carried in the UHR-SIG field.

In some embodiments, the UHR PPDU contains two repeated UHR-STFs, and the two repeated UHR-STFs indicate that the UHR PPDU contains the ID field.

In some embodiments, the UHR PPDU contains an ID symbol, and the ID symbol indicates that the UHR PPDU contains the ID field.

In some embodiments, the ID symbol is carried in at least one of the following fields in the UHR PPDU: an L-SIG, an RL-SIG, a UHR-STF, a UHR-LTF, a U-SIG, a UHR-SIG, or a data field.

In some embodiments, a pilot mapping matrix for a subcarrier on the ID symbol indicates that the UHR PPDU contains the ID field.

In some embodiments, the pilot mapping matrix for the subcarrier on the ID symbol is determined in a first manner, the first manner is different from a second manner, the second manner is used for determining a pilot mapping matrix for a subcarrier on a non-ID symbol, and the second manner is a predefined manner.

In some embodiments, the pilot mapping matrix for the subcarrier on the ID symbol is determined to be a first pilot mapping matrix in the first manner, the pilot mapping matrix for the subcarrier on the ID symbol is determined to be a second pilot mapping matrix in the second manner, and a value of an element in the first pilot mapping matrix is an opposite number of a value of a corresponding element in the second pilot mapping matrix.

In some embodiments, the pilot mapping matrix for the subcarrier on the ID symbol is determined to be a first pilot mapping matrix in the first manner, a pilot mapping matrix for a subcarrier on a first symbol is also determined to be the first pilot mapping matrix in the second manner, and the ID symbol and the first symbol are adjacent symbols.

In some embodiments, an average power for transmitting the ID field is the same as an average power for transmitting a data field in the UHR PPDU.

In some embodiments, a duration of the ID field is a fixed value, or the duration of the ID field is variable.

In some embodiments, the transmitting device is an AP device or an STA device.

Optionally, in some embodiments, the communication unit may be a communication interface or a transceiver, or an input/output interface of a communication chip or a system-on-chip (SOC). The processing unit may be one or more processors.

It may be understood that, the transmitting device 400 in embodiments of the present disclosure may correspond to the transmitting device in the method embodiments of the present disclosure, and other operations and/or functions of the respective units in the transmitting device 400 are respectively used to implement the corresponding procedures of the transmitting device in the method 200 as illustrated in FIG. 9 to FIG. 40. For the sake of brevity, such details are not repeated herein.

FIG. 42 is a schematic block diagram of a receiving device according to embodiments of the present disclosure. The receiving device 500 illustrated in FIG. 42 includes a communication unit 510. The communication unit 510 is configured to transmit one or more UHR PPDUs, where the UHR PPDU contains an ID field, and the ID field indicates ID information of the transmitting device.

In some embodiments, a subcarrier used for the ID field indicates the ID information of the transmitting device.

In some embodiments, the UHR PPDU is a UHR MU PPDU, a UHR TB PPDU, or a UHR ER PPDU.

In some embodiments, the UHR PPDU does not contain a PE field, and the ID field is carried at the tail of the UHR PPDU.

In some embodiments, the UHR PPDU contains a PE field, and the ID field is positioned before the PE field.

In some embodiments, the UHR PPDU further contains a reverse interval field, and the reverse interval field is used for reserving an interval for a receiving device of the UHR PPDU to reverse from a receiving state to a transmitting state.

In some embodiments, the reverse interval field is positioned before the ID field.

In some embodiments, the ID field contains one or more ID subfields, and the one or more ID subfields indicate the ID information of the transmitting device.

In some embodiments, the ID field further contains a UHR-STF.

In some embodiments, the ID field further contains one or more UHR-LTFs.

In some embodiments, the ID field further contains a legacy preamble field.

In some embodiments, the legacy preamble field contains the following fields: an L-STF, an L-LTF, an L-SIG, an RL-SIG, and a U-SIG.

In some embodiments, the legacy preamble field contains the following fields: an L-STF, an L-LTF, an L-SIG, a RL-SIG, a U-SIG, and a UHR-SIG.

In some embodiments, a subcarrier used for the one or more ID subfields indicates the ID information of the transmitting device.

In some embodiments, the ID information of the transmitting device corresponds to two subcarrier sets, and a subcarrier used for the ID subfield belongs to one of the two subcarrier sets.

In some embodiments, the subcarrier used for the ID subfield belonging to different subcarrier sets of the two subcarrier sets indicates different state information of the transmitting device, respectively.

In some embodiments, a bandwidth for the ID subfield is 20 MHz, 40 MHz, 80 MHz, 80+80 MHz, 160 MHz, or 320 MHz.

In some embodiments, the 320 MHz is represented by subcarrier set indices of four 80 MHz, where subcarrier set indices 1-72 are mapped to a first 80 MHz, subcarrier set indices 73-144 are mapped to a second 80 MHz, subcarrier set indices 145-216 are mapped to a third 80 MHz, and subcarrier set indices 217-288 are mapped to a fourth 80 MHz.

In some embodiments, the ID information of the transmitting device corresponds to one subcarrier set, and a subcarrier used for the ID subfield belongs to the subcarrier set.

In some embodiments, a correspondence between the ID information of the transmitting device and the subcarrier set is predefined.

In some embodiments, the UHR PPDU further contains a control field, and the control field indicates whether the UHR PPDU contains the ID field and/or configuration information of the ID field.

In some embodiments, the configuration information of the ID field includes at least one of: the number of ID subfields contained in the ID field, usage of the ID field, or the number of devices that are multiplexed on one set of subcarriers in a same RU.

In some embodiments, the control field contains at least one of the following fields: an ID present field indicating whether the ID field is present in the UHR PPDU; a first number field indicating the number of ID subfields contained in the ID field; a usage field indicating usage of the ID field; or a second number field indicating the number of devices that are multiplexed on one set of subcarriers in a same RU.

In some embodiments, the UHR PPDU contains a U-SIG field, and the control field is carried in the U-SIG field.

In some embodiments, the UHR PPDU contains a UHR-SIG field, and the control field is carried in the UHR-SIG field.

In some embodiments, the UHR PPDU contains two repeated UHR-STFs, and the two repeated UHR-STFs indicate that the UHR PPDU contains the ID field.

In some embodiments, the UHR PPDU contains an ID symbol, and the ID symbol indicates that the UHR PPDU contains the ID field.

In some embodiments, the ID symbol is carried in at least one of the following fields in the UHR PPDU: an L-SIG, an RL-SIG, a UHR-STF, a UHR-LTF, a U-SIG, a UHR-SIG, or a data field.

In some embodiments, a pilot mapping matrix for a subcarrier on the ID symbol indicates that the UHR PPDU contains the ID field.

In some embodiments, the pilot mapping matrix for the subcarrier on the ID symbol is determined in a first manner, the first manner is different from a second manner, the second manner is used for determining a pilot mapping matrix for a subcarrier on a non-ID symbol, and the second manner is a predefined manner.

In some embodiments, the pilot mapping matrix for the subcarrier on the ID symbol is determined to be a first pilot mapping matrix in the first manner, the pilot mapping matrix for the subcarrier on the ID symbol is determined to be a second pilot mapping matrix in the second manner, and a value of an element in the first pilot mapping matrix is an opposite number of a value of a corresponding element in the second pilot mapping matrix.

In some embodiments, the pilot mapping matrix for the subcarrier on the ID symbol is determined to be a first pilot mapping matrix in the first manner, a pilot mapping matrix for a subcarrier on a first symbol is also determined to be the first pilot mapping matrix in the second manner, and the ID symbol and the first symbol are adjacent symbols.

In some embodiments, the receiving device further includes a processing unit. The processing unit is configured to transmit a first primitive to an SME or an MLME of the receiving device, where the first primitive indicates a detection result of the transmitting device obtained from the one or more UHR PPDUs.

In some embodiments, the detection result of the transmitting device includes at least one of: the number of transmitting devices detected from the ID field; an ID list of the transmitting devices detected from the ID field; state information of the transmitting devices detected from the ID field; or usage of the ID field.

In some embodiments, the first primitive is generated when the PHY of the receiving device successfully receives the ID field and completes detection of the transmitting device from the ID field, and the first primitive is used for reporting the detection result of the transmitting device to the MLME or the SME of the receiving device.

In some embodiments, the SME or the MLME of the receiving device obtains the detection result of the transmitting device from the first primitive.

In some embodiments, an average power for transmitting the ID field is the same as an average power for transmitting a data field in the UHR PPDU.

In some embodiments, a duration of the ID field is a fixed value, or the duration of the ID field is variable.

In some embodiments, the transmitting device is an AP device or an STA device.

In some embodiments, the receiving device is an STA device or an AP device.

Optionally, in some embodiments, the communication unit may be a communication interface or a transceiver, or an input/output interface of a communication chip or an SOC. The processing unit may be one or more processors.

It may be understood that, the receiving device 500 in embodiments of the present disclosure may correspond to the receiving device in the method embodiments of the present disclosure, and other operations and/or functions of the respective units in the receiving device 500 are respectively used to implement the corresponding procedures of the receiving device in the method 200 as illustrated in FIG. 9 to FIG. 40. For the sake of brevity, such details are not repeated herein.

FIG. 43 is a schematic structural diagram of a communication device 600 provided in embodiments of the present disclosure. As illustrated in FIG. 43, the communication device 600 includes a processor 610, where the processor 610 can invoke and execute a computer program stored in a memory to implement the method in embodiments of the present disclosure.

Optionally, as illustrated in FIG. 43, the communication device 600 may further include a memory 620. The processor 610 can invoke and execute a computer program stored in the memory 620 to implement the method in embodiments of the present disclosure.

The memory 620 may be a separate device independent of the processor 610, or may be integrated into the processor 610.

Optionally, as illustrated in FIG. 43, the communication device 600 may further include a transceiver 630. The processor 610 may control the transceiver 630 to communicate with other devices, specifically, the processor 610 may control the transceiver 630 to send information or data to, or receive information or data from, other devices.

The transceiver 630 may include a transmitter and a receiver. The transceiver 630 may further include one or more antennas.

Optionally, the communication device 600 may specifically be the receiving device in embodiments of the present disclosure, and the communication device 600 may implement corresponding operations implemented by the receiving device in various methods in embodiments of the present disclosure, which will not be repeated herein for the sake of brevity.

Optionally, the communication device 600 may specifically be the transmitting device in embodiments of the present disclosure, and the communication device 600 may implement corresponding operations implemented by the transmitting device in various methods in embodiments of the present disclosure, which will not be repeated herein for the sake of brevity.

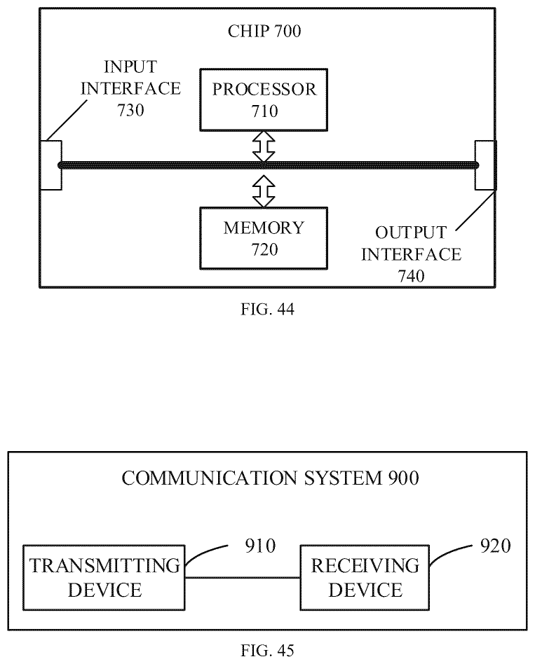

FIG. 44 is a schematic structural diagram of a chip provided in embodiments of the present disclosure. As illustrated in FIG. 44, the chip 700 includes a processor 710, where the processor 710 can invoke and execute a computer program stored in a memory to implement the method in embodiments of the present disclosure.

Optionally, as illustrated in FIG. 44, the chip 700 may further include a memory 720. The processor 710 can invoke and execute a computer program stored in the memory 720 to implement the method in embodiments of the present disclosure.

The memory 720 may be a separate device independent of the processor 710, or may be integrated into the processor 710.

Optionally, the chip 700 may further include an input interface 730. The processor 710 may control the input interface 730 to communicate with other devices or chips. Specifically, the processor 710 can obtain information or data sent by other devices or chips.

Optionally, the chip 700 may further include an output interface 740. The processor 710 may control the output interface 740 to communicate with other devices or chips. Specifically, the processor 710 may output information or data to other devices or chips.

Optionally, the chip is applicable to the transmitting device in embodiments of the present disclosure, and the chip may implement the corresponding operations performed by the transmitting device in various methods of embodiments of the present disclosure. For the sake of brevity, such details are not repeated herein.

Optionally, the chip is applicable to the receiving device in embodiments of the present disclosure, and the chip may implement the corresponding operations performed by the receiving device in various methods of embodiments of the present disclosure. For the sake of brevity, such details are not repeated herein.

It may be understood that, the chip in embodiments of the present disclosure may also be referred to as a system-level chip, a system chip, a chip system, or a system-on-chip (SOC).

FIG. 45 is a schematic block diagram of a communication system 900 provided in an embodiment of the present disclosure. As illustrated in FIG. 45, the communication system 900 includes a transmitting device 910 and a receiving device 920.

The transmitting device 910 may be configured to implement the corresponding functions performed by the transmitting device in the method, and the receiving device 920 may be configured to implement the corresponding functions performed by the receiving device in the method. For the sake of brevity, such details are not repeated herein.

It may be understood that, the processor in embodiments of the present disclosure may be an integrated circuit chip with signal processing capabilities. During implementation, each step of the foregoing method embodiments may be completed by an integrated logic circuit of hardware in the processor or instructions in the form of software. The processor may be a general-purpose processor, a digital signal processor (DSP), an application-specific integrated circuit (ASIC), a field programmable gate array (FPGA), or other programmable logic devices, discrete gates or transistor logic devices, or discrete hardware components. The methods, steps, and logic blocks disclosed in embodiments of the present disclosure can be implemented or executed. The general-purpose processor may be a microprocessor, or the processor may be any conventional processor or the like. The steps of the method disclosed in embodiments of the present disclosure may be directly implemented by a hardware decoding processor, or may be performed by hardware and software modules in the decoding processor. The software module can be positioned in a storage medium well known in the art, such as a random access memory (RAM), a flash memory, a read-only memory (ROM), a programmable ROM (PROM), or an electrically erasable programmable memory, registers, and the like. The storage medium is positioned in the memory. The processor is configured to read the information in the memory, and complete the steps of the method described above with the hardware thereof.

It may be understood that, the memory in embodiments of the present disclosure may be a volatile memory or a non-volatile memory, or may include both the volatile memory and the non-volatile memory. The non-volatile memory may be a ROM, a PROM, an erasable PROM (EPROM), an electrically EPROM (EEPROM), or a flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It may be noted that, the memory of the systems and methods described in the present disclosure is intended to include, but is not limited to, these and any other suitable types of memory.

It may be understood that, the memory above is intended for illustration rather than limitation. For example, the memory in embodiments of the present disclosure may also be an SRAM, a DRAM, an SDRAM, a DDR SDRAM, an ESDRAM, an SLDRAM, a DR RAM, etc. In other words, the memory in embodiments of the present disclosure is intended to include, but is not limited to, these and any other suitable types of memory.

Embodiments of the present disclosure further provide a computer-readable storage medium. The computer-readable storage medium is configured to store a computer program.

Optionally, the computer-readable storage medium is applicable to the transmitting device in embodiments of the present disclosure, and the computer program may cause a computer to perform the corresponding processes implemented by the transmitting device in various methods of embodiments of the present disclosure. For simplicity, details are not repeated herein.

Optionally, the computer-readable storage medium is applicable to the receiving device in embodiments of the present disclosure, and the computer program may cause a computer to perform the corresponding processes implemented by the receiving device in various methods of embodiments of the present disclosure. For simplicity, details are not repeated herein.

Embodiments of the present disclosure further provide a computer program product. The computer program product includes computer program instructions.

Optionally, the computer program product is applicable to the transmitting device in embodiments of the present disclosure, and the computer program instructions may cause a computer to perform the corresponding processes implemented by the transmitting device in various methods of embodiments of the present disclosure. For simplicity, details are not repeated herein.

Optionally, the computer program product is applicable to the receiving device in embodiments of the present disclosure, and the computer program instructions may cause a computer to perform the corresponding processes implemented by the receiving device in various methods of embodiments of the present disclosure. For simplicity, details are not repeated herein.

Embodiments of the present disclosure further provide a computer program.

Optionally, the computer program is applicable to the transmitting device in embodiments of the present disclosure, and the computer program may cause the computer to perform the corresponding processes implemented by the transmitting device in various methods of embodiments of the present disclosure. For simplicity, details are not repeated herein.

Optionally, the computer program is applicable to the receiving device in embodiments of the present disclosure, and the computer program may cause a computer to perform the corresponding processes implemented by the receiving device in various methods of embodiments of the present disclosure. For simplicity, details are not repeated herein.

Those of ordinary skill in the art may appreciate that units and algorithmic operations of various examples described in connection with embodiments of the present disclosure may be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods can not be regarded as lying beyond the scope of the present disclosure.

It may be evident to those skilled in the art that, for the sake of convenience and brevity, in terms of the specific working processes of the foregoing systems, apparatuses, and units, reference can be made to the corresponding processes in the foregoing method embodiments, which will not be repeated herein.

It may be appreciated that the systems, apparatuses, and methods disclosed in embodiments of the present disclosure may also be implemented in various other manners. For example, the apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interfaces, devices, or units, and may be electrical, mechanical, or otherwise.

Separated units as illustrated may or may not be physically separated. Components displayed as units may or may not be physical units, and may reside at one position or may be distributed to multiple networked units. Some or all of the units may be selectively adopted according to practical needs to achieve desired objectives of the present disclosure.

In addition, various functional units described in various embodiments of the present disclosure may be integrated into one processing unit or may be present as the number of physically separated units, and two or more units may be integrated into one.

If the functions are implemented as software functional units and sold or used as standalone products, they may be stored in a computer-readable storage medium. Based on such an understanding, the essential technical solution, or the portion that contributes to the related art, or part of the technical solution of the present disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the present disclosure. The storage medium may include various kinds of media that can store program codes, such as a universal serial bus (USB) flash disk, a mobile hard drive, an ROM, an RAM, a magnetic disk, or an optical disk.

The foregoing elaborations are merely implementations of the present disclosure, but are not intended to limit the protection scope of the present disclosure. Any variation or replacement easily thought of by those skilled in the art within the technical scope disclosed in the present disclosure shall belong to the protection scope of the present disclosure. Therefore, the protection scope of the present disclosure shall be subject to the protection scope of the claims.

What is claimed is:

1. A method for wireless communication, comprising:
transmitting, by a transmitting device, an ultra-high reliability (UHR) physical layer (PHY) protocol data unit (PPDU), wherein the UHR PPDU contains at least one of: a legacy short training field (L-STF), a legacy long training field (L-LTF), a legacy signal field (L-SIG), a repeated legacy signal field (RL-SIG), a universal signal field (U-SIG), an ultra-high reliability signal field (UHR-SIG), an ultra-high reliability short training field (UHR-STF), an ultra-high reliability long training field (UHR-LTF), a data field, or a packet extension (PE) field.

2. The method of claim 1, wherein the UHR PPDU contains an identifier (ID) field, the ID field indicates ID information of the transmitting device, and a subcarrier used for the ID field indicates the ID information of the transmitting device.

3. The method of claim 1, wherein the UHR PPDU is an ultra-high reliability multi-user physical layer protocol data unit (UHR MU PPDU), an ultra-high reliability trigger-based physical layer protocol data unit (UHR TB PPDU), or an ultra-high reliability extended range physical layer protocol data unit (UHR ER PPDU).

4. The method of claim 1, wherein the UHR PPDU does not contain a packet extension (PE) field, and the ID field is carried at a tail of the UHR PPDU.

5. The method of claim 1, wherein the UHR PPDU contains a PE field, and the ID field is positioned before the PE field.

6. The method of claim 1, wherein the UHR PPDU further contains a reverse interval field, and the reverse interval field is used for reserving an interval for a receiving device of the UHR PPDU to reverse from a receiving state to a transmitting state.

7. The method of claim 6, wherein the reverse interval field is positioned before the ID field.

8. The method of claim 1, wherein the ID field contains one or more ID subfields, and the one or more ID subfields indicate the ID information of the transmitting device.

9. The method of claim 8, wherein the ID field further contains an ultra-high reliability short training field (UHR-STF).

10. The method of claim 9, wherein the ID field further contains one or more ultra-high reliability long training fields (UHR-LTFs).

11. The method of claim 8, wherein the ID field further contains a legacy preamble field.

12. The method of claim 11, wherein the legacy preamble field contains the following fields:
a legacy short training field (L-STF), a legacy long training field (L-LTF), a legacy signal field (L-SIG), a repeated legacy signal field (RL-SIG), and a universal signal field (U-SIG).

13. The method of claim 11, wherein the legacy preamble field contains the following fields:
an L-STF, an L-LTF, an L-SIG, a RL-SIG, a U-SIG, and an ultra-high reliability signal field (UHR-SIG).

14. The method of claim 8, wherein a subcarrier used for the one or more ID subfields indicates the ID information of the transmitting device.

15. The method of claim 8, wherein the ID information of the transmitting device corresponds to two subcarrier sets, and a subcarrier used for the ID subfield belongs to one of the two subcarrier sets.

16. The method of claim 15, wherein the subcarrier used for the ID subfield belonging to different subcarrier sets of the two subcarrier sets indicates different state information of the transmitting device, respectively.

17. The method of claim 15, wherein a bandwidth for the ID subfield is 20 MHz, 40 MHz, 80 MHz, 80+80 MHz, 160 MHz, or 320 MHz.

18. The method of claim 17, wherein the 320 MHz is represented by subcarrier set indices of four 80 MHz, wherein subcarrier set indices 1-72 are mapped to a first 80 MHz, subcarrier set indices 73-144 are mapped to a second 80 MHz, subcarrier set indices 145-216 are mapped to a third 80 MHz, and subcarrier set indices 217-288 are mapped to a fourth 80 MHz.

19. The method of claim 8, wherein the ID information of the transmitting device corresponds to one subcarrier set, and a subcarrier used for the ID subfield belongs to the subcarrier set.

20. A transmitting device, comprising:
a memory configured to store a computer program; and
a processor configured to invoke and execute the computer program stored in the memory, to cause the transmitting device to:
transmit an ultra-high reliability (UHR) physical layer (PHY) protocol data unit (PPDU), wherein the UHR PPDU contains at least one of: a legacy short training field (L-STF), a legacy long training field (L-LTF), a legacy signal field (L-SIG), a repeated legacy signal field (RL-SIG), a universal signal field (U-SIG), an ultra-high reliability signal field (UHR-SIG), an ultra-high reliability short training field (UHR-STF), an ultra-high reliability long training field (UHR-LTF), a data field, or a packet extension (PE) field.
